(19) United States
(12) Patent Application Publication
(10) Pub. No.: US 2016/0277448 A1
(43) Pub. Date: Sep. 22, 2016

(54) MANAGEMENT SYSTEM, MANAGEMENT METHOD AND MANAGEMENT SERVER FOR COMMUNICATION TERMINALS, TERMINAL CONTROL METHOD, AND COMMUNICATION TERMINAL

(71) Applicant: NEC CORPORATION, Tokyo (JP)

(72) Inventors: Yoshinori SAIDA, Tokyo (JP); Shuichi KARINO, Tokyo (JP); Yoshikazu WATANABE, Tokyo (JP); Gen MORITA, Tokyo (JP); Takahiro IIHOSHI, Tokyo (JP)

(73) Assignee: NEC Corporation, Tokyo (JP)

(21) Appl. No.: 15/033,431

(22) PCT Filed: Oct. 27, 2014
(86) PCT No.: PCT/JP2014/005421

§ 371 Date: Apr. 29, 2016

(30) Foreign Application Priority Data
Oct. 30, 2013 (JP) 2013-225084

(51) Int. Cl. H04L 29/06; H04L 12/24

(52) U.S. Cl. CPC H04L 63/20; H04L 67/42; H04L 41/0813; H04L 63/08

(57) ABSTRACT

A system, a method and a server for managing a communication terminal as well as a terminal control method are provided that make it possible to easily use a privately owned communication terminal in business. A management system for managing a terminal (300) owned by a user (400) includes: a gate (100) that determines the user's entrance into or exit from a predetermined place; and a management server 200 that determines an operation policy based on at least a result of the determination made by the gate (100) and sets this operation policy on the terminal (300).

### TECHNICAL FIELD

The present invention relates to a system for managing a communication terminal that performs communication through a network connection and, more particularly, to a management system, a management method and a management server for controlling the operation mode of a communication terminal, as well as to a terminal control method and a communication terminal.

### BACKGROUND ART

Use of personally owned terminals in business at companies (BYOD: Bring Your Own Device) is becoming commonplace, following the proliferation of smartphones and tablet-type terminals and the development of infrastructures for wireless network environments. On the other hand, in BYOD usage, problems with security are pointed out, such as risks of leakage of corporate information caused by the use of privately owned terminals. For such problems, PTL 1 discloses an example of a system intended to enhance BYOD security.

A mobile terminal disclosed in PTL 1 determines a user's arriving at/leaving the office based on the proximity to a gate, and is controlled to switch to a public mode when the user arrives at the office, or to switch to a private mode when the user leaves the office.

### CITATION LIST

### Patent Literature

### [PTL 1]

Japanese Patent Application Unexamined Publication No. 2007-221398

### SUMMARY OF INVENTION

### Technical Problem

However, the mobile terminal disclosed in PTL 1 requires an authentication function for allowing the user to pass the gate, for example, a function like a contactless employee ID card utilizing NFC (Near Field Communication) or the like. PTL 1 therefore has the disadvantage that mobile terminals equipped with no contactless authentication function cannot be applied to the above-described BYOD.

As described above, according to the technique disclosed in PTL 1, when privately owned terminals are used in business, some types of mobile terminals cannot be used, which may pose a barrier to the promotion of BYOD usage of privately owned terminals. Moreover, the mobile terminal according to PTL 1 needs to be provided with two telephone numbers for private and public modes, respectively, and is premised on a subscription to a particular service provided by a carrier, which also forms a barrier to the promotion of BYOD.

Accordingly, an object of the present invention is to provide a system, a method and a server for managing a communication terminal, a terminal control method and a communication terminal that solve the above-described problems and make it possible to easily use a privately owned communication terminal in business.

### Solution to Problem

A management system according to the present invention is a management system for managing a terminal owned by a user, characterized by including: an entrance/exit detection device that detects the user's entrance into or exit from a predetermined place; and a management device that notifies an operation policy of the terminal to this terminal in response to detection of entrance/exit by the entrance/exit determination device.

A management method according to the present invention is a management method for managing a terminal owned by a user, characterized by including: by an entrance/exit detection device, detecting the user's entrance into or exit from a predetermined place; and by a management device, notifying an operation policy of the terminal to this terminal in response to the fact that the entrance/exit determination device has detected the entrance/exit.

A management server according to the present invention is a management server for managing a terminal owned by a user, characterized by including: a communication means that receives from an entrance/exit detection means a notification indicating that the user's entrance into or exit from a predetermined place has been detected; and a control means that notifies an operation policy of the terminal to this terminal in response to the notification.

A terminal control method for a management server according to the present invention is a terminal control method for a management server that manages a terminal owned by a user, characterized by including: by a communication means, receiving from an entrance/exit detection means a notification indicating that the user's entrance into or exit from a predetermined place has been detected; and by a control means, notifying an operation policy of the terminal to this terminal in response to the notification.

A communication terminal according to the present invention is a communication terminal owned by a user that is managed by a management server, characterized by including: a communication means that receives an operation policy, which is notified by the management server based on a result of detection, from an entrance/exit detection means, of the user's entrance into or exit from a predetermined place; and a control means for controlling operation of this communication terminal through functional settings according to the operation policy.

### Advantageous Effects of Invention

According to the present invention, it is possible to easily use a privately owned terminal in business, without changing the functions of the privately owned communication terminal.

### BRIEF DESCRIPTION OF DRAWINGS

FIG. 1 is a system architecture diagram for describing general operation in a management system according to a first exemplary embodiment of the present invention.

FIG. 2 is a block diagram showing the functional configuration of a management server according to the first exemplary embodiment.

FIG. 3 is a block diagram showing the functional configuration of a communication terminal according to the first exemplary embodiment.

FIG. 4 is a schematic diagram showing an example of information stored in a user information database at the management server shown in FIG. 2.

FIG. 5 is a schematic diagram showing another example of the information stored in the management server's user information database at the management server shown in FIG. 2.

FIG. 6 is a schematic diagram showing an example of a policy database at the management server shown in FIG. 2.

FIG. 7 is a schematic diagram showing an example of information including use restrictions stored in the user information database at the management server shown in FIG. 2.

FIG. 8 is a schematic diagram showing another example of the information including use restrictions stored in the user information database at the management server shown in FIG. 2.

FIG. 9 is a sequence diagram showing overall operation in the management system shown in FIG. 1.

FIG. 10 is a schematic diagram showing an example of information settings in the user information database at the management server shown in FIG. 2.

FIG. 11 is a schematic diagram showing another example of the information settings in the user information database at the management server shown in FIG. 2.

FIG. 12 is a system architecture diagram for describing a first example of operation when a terminal in a management system according to a second exemplary embodiment of the present invention moves from the outside to the inside of the office.

FIG. 13 is a system architecture diagram for describing a second example of operation when a terminal in the management system according to the second exemplary embodiment moves from the outside to the inside of the office.

FIG. 14 is a system architecture diagram for describing a third example of operation when a terminal in the management system according to the second exemplary embodiment moves from the outside to the inside of the office.

FIG. 15 is a system architecture diagram for describing a fourth example of operation when a terminal in the management system according to the second exemplary embodiment moves from the outside to the inside of the office.

FIG. 16 is a system architecture diagram for describing a fifth example of operation when a terminal in the management system according to the second exemplary embodiment moves from the outside to the inside of the office.

FIG. 17 is a system architecture diagram for describing a first example of operation when a terminal in the management system according to the second exemplary embodiment moves from the inside to the outside of the office.

FIG. 18 is a system architecture diagram for describing a second example of operation when a terminal in the management system according to the second exemplary embodiment moves from the inside to the outside of the office.

FIG. 19 is a system architecture diagram for describing a third example of operation when a terminal in the management system according to the second exemplary embodiment moves from the inside to the outside of the office.

FIG. 20 is a system architecture diagram for describing a fourth example of operation when a terminal in the management system according to the second exemplary embodiment moves from the inside to the outside of the office.

FIG. 21 is a system architecture diagram for describing a fifth example of operation when a terminal in the management system according to the second exemplary embodiment moves from the inside to the outside of the office.

FIG. 22 is a system architecture diagram for describing a first example of operation when a terminal in a management system according to a third exemplary embodiment of the present invention moves from the outside to the inside of the office.

FIG. 23 is a system architecture diagram for describing a second example of operation when a terminal in the management system according to the third exemplary embodiment moves from the outside to the inside of the office.

FIG. 24 is a system architecture diagram for describing a third example of operation when a terminal in the management system according to the third exemplary embodiment moves from the outside to the inside of the office.

FIG. 25 is a system architecture diagram for describing a first example of operation when a terminal in the management system according to the third exemplary embodiment moves from the inside to the outside of the office.

FIG. 26 is a system architecture diagram for describing a second example of operation when a terminal in the management system according to the third exemplary embodiment moves from the inside to the outside of the office.

FIG. 27 is a system architecture diagram for describing a third example of operation when a terminal in the management system according to the third exemplary embodiment moves from the inside to the outside of the office.

FIG. 28 is a system architecture diagram for describing general operation in a management system according to a fourth exemplary embodiment of the present invention.

FIG. 29 is a system architecture diagram showing an example of the management system according to the fourth exemplary embodiment.

FIG. 30 is a system architecture diagram for describing general operation in a management system according to a fifth exemplary embodiment of the present invention.

FIG. 31 is a system architecture diagram for describing general operation in a management system according to a sixth exemplary embodiment of the present invention.

FIG. 32 is a block diagram showing the functional configuration of a management server according to a seventh exemplary embodiment of the present invention.

FIG. 33 is a system architecture diagram showing a first example of a management system according to the seventh exemplary embodiment.

FIG. 34 is a system architecture diagram showing a second example of the management system according to the seventh exemplary embodiment.

FIG. 35 is a block diagram showing the functional configuration of a management server according to an eighth exemplary embodiment of the present invention.

### DESCRIPTION OF EMBODIMENTS

Hereinafter, exemplary embodiments of the present invention will be described in detail with reference to drawings.

### 1. First Exemplary Embodiment

### 1.1) Outline

According to a first exemplary embodiment of the present invention, when a user owning a terminal passes a gate and, for example, enters or leaves the office, a management server changes policy settings on this terminal to adapt to the use inside or outside the office, or the use within or out of working hours. Examples of the policy settings adequate to the use inside the office include restriction on the use of a device such as a camera mounted on the terminal, restriction on the use of a specific application, and the like. Moreover, examples of the policy settings adequate to the use outside the office include restriction on the use of a business application, disabled access to business data, and the like.

As described above, the management server can set an adequate policy according to the location of a user on a terminal owned by the user, depending on the user's passing the gate. Thus, it is possible to use privately owned terminals in business, without changing the functions of the terminals owned by users.

In the present exemplary embodiment, application to an office of a company will be described. However, the present exemplary embodiment is not limited to such a case. For example, the present exemplary embodiment can be applied to not only companies but also schools and the like. Hereinafter, a management system and a management server according to the first exemplary embodiment will be described in detail with reference to drawings.

### 1.2) System Architecture

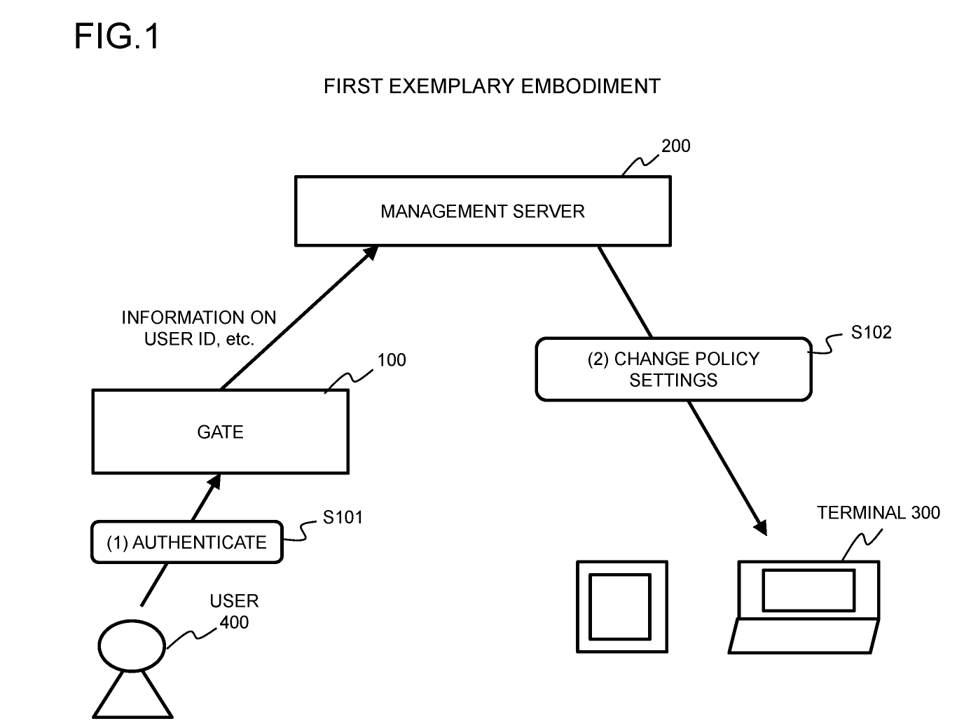

Referring to FIG. 1, the management system according to the present exemplary embodiment includes a gate 100, a management server 200 and a terminal 300. It is assumed that the terminal 300 is owned by a user 400. Here, as an example, it is assumed that the user 400 moves to the inside or outside of the office via the gate 100.

The gate 100 is installed in the office a user belong to, and only needs to be an entrance/exit determination device that can determine the user's entrance into or exit from the office. For example, a user owns an employee ID card (ID card or IC card) equipped with a contactless IC function. The user brings the employee ID card closer to, or touches the employee ID card onto, the gate 100, whereby user authentication is performed and the user can pass the gate 100. The gate 100 may also include a function of opening/closing a flapper gate (paddle gate or flapper gate) and a function of unlocking a door. Moreover, the gate 100 may also include a biometric authentication function.

The management server 200 manages the state of each user (inside/outside the office), the operational state of a terminal owned by each user, policies set on the terminals, and the like. The management server 200 operates in cooperation with the existing gate 100 and thereby can control the operation mode of the terminal 300, which will be described later. The management server 200 may be, for example, an MDM (Mobile Device Management) server. The management server 200 will be described later.

The terminal 300 is assumed to be a privately owned terminal owned by the user 400. Examples of the terminal 300 include a mobile telephone such as a smartphone, a tablet-type terminal, a note PC (Personal Computer) and the like. The terminal 300 will be described later.

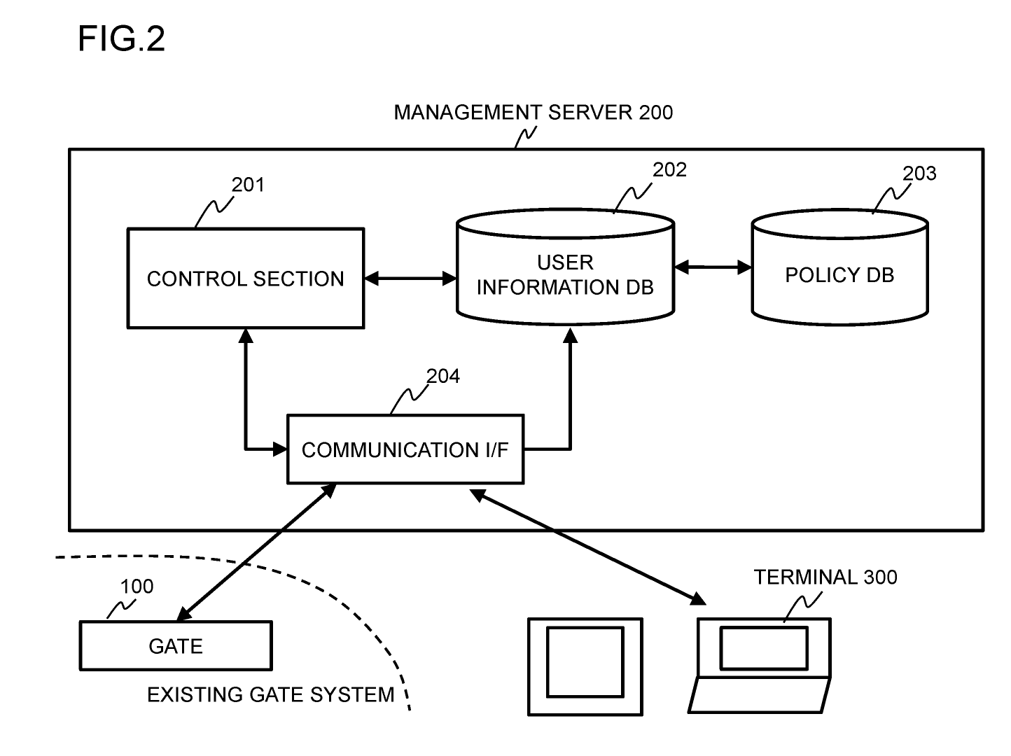

Referring to FIG. 2, the management server 200 includes a control section 201, a user information DB (Data Base) 202, a policy DB 203 and a communication interface (hereinafter, I/F) 204. When information on a user who has passed the gate 100 is received via the communication I/F 204, the control section 201 searches the user information DB 202 and policy DB 203 by using this user information and determines a policy to be set on the terminal 300 of the user who has passed the gate 100. The control section 201 can be implemented by executing programs for policy setting control on a processor.

The user information DB 202 is a database storing user information, which is registered beforehand, whereas the policy DB 203 is a database storing policy information set on terminals. The user information DB 202 and policy DB 203 will be described later.

The communication I/F 204, which is a communication interface for performing communication with the gate 100 and terminal 300, can receive user information from the gate 100 and can send/receive terminal information and policy setting information to/from the terminal 300.

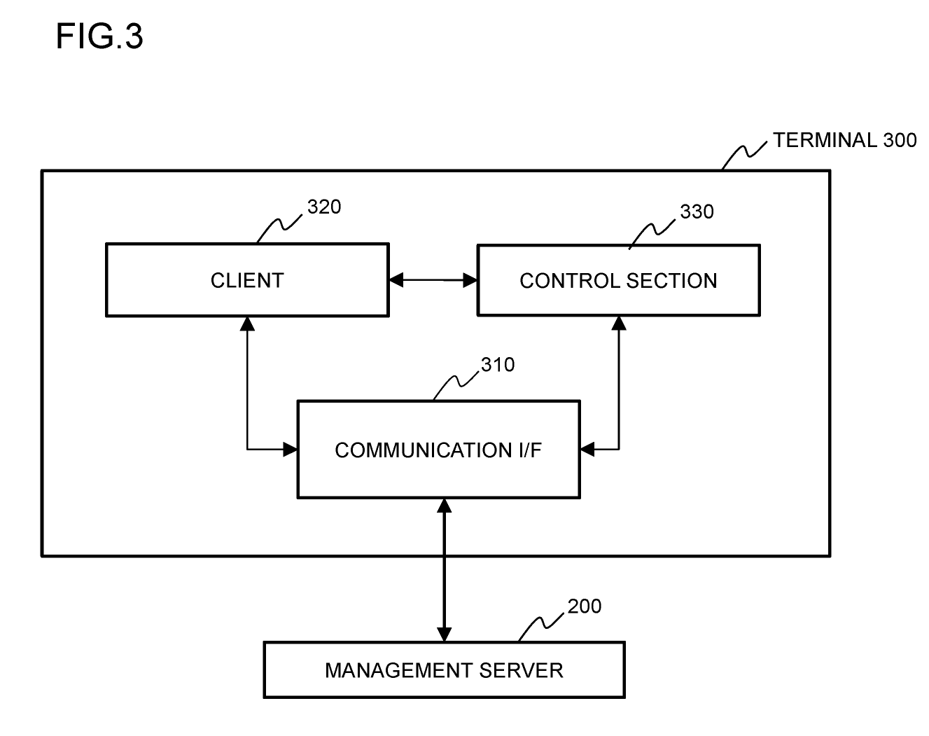

Referring to FIG. 3, the terminal 300 includes a communication I/F 310, a client 320 and a control section 330. The communication I/F 310 is an interface for performing communication with management means such as the management server 200, an SMS (Short Message Service) server and a push server, which will be described later.

The client 320, which is a function implemented by client programs executed on a processor, makes settings instructed by the management server 200 or the like, or interprets a setting command and makes policy settings. Note that policies to be set on the terminal 300 may be registered with the client 320 beforehand. Moreover, it is also possible that even if a policy is not registered with the client 320, restriction on the use of an application and a device and the like can be set as appropriate, which will be described in exemplary embodiments below.

The control section 303, which is a processor controlling the overall operation of the terminal 300, controls the operation of the terminal 300 in accordance with a policy set by the client 320.

### <User Information Database>

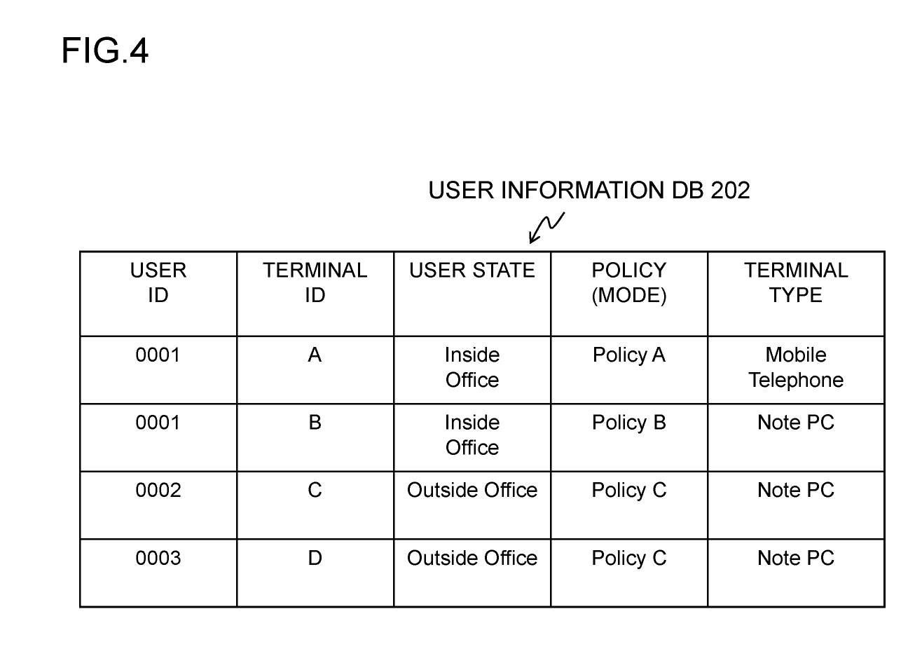

The user information DB 202 illustrated in FIG. 4 stores user IDs, IDs of terminals owned by the users, states of the users, policies set on the terminals, and types of the terminals. A user ID is an identifier such as an employee number that can identify an individual person. Moreover, a terminal ID only needs to be an identifier that can identify a terminal of interest, and, for example, a MAC (Media Access Control) address can be used.

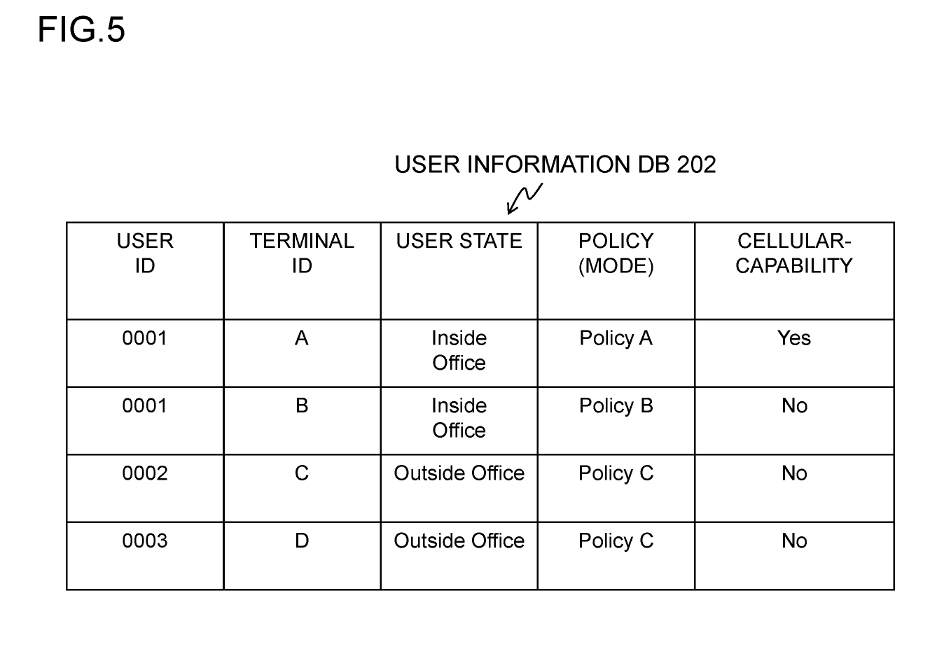

In the example shown in FIG. 4, a user of user ID “0001” (hereinafter, referred to as the user 0001) is located inside the office and owns two different terminals of terminal ID “A” and terminal ID “B”. Further, referring to “TERMINAL TYPE”, the terminal of terminal ID=A (hereinafter, referred to as the terminal A) is a mobile telephone, whereas the terminal of terminal ID=B (hereinafter, referred to as the terminal B) is a note PC. With respect to the terminal type, it is only necessary that determination can be made on whether or not a cellular network for 3G, LTE (Long Term Evolution) or the like can be used. Accordingly, the user information DB 202 may store information on whether or not each terminal can use a cellular network, as shown in FIG. 5. In the example of FIG. 5, only the terminal A is a mobile telephone and can use a cellular network. It can be seen that the other terminals are note PCs and therefore cannot use a cellular network. Moreover, it is possible to set different policies on the terminals, respectively. In the examples shown in FIGS. 4 and 5, policies A and B are set on the terminals A and B, respectively.

### <Policy Database>

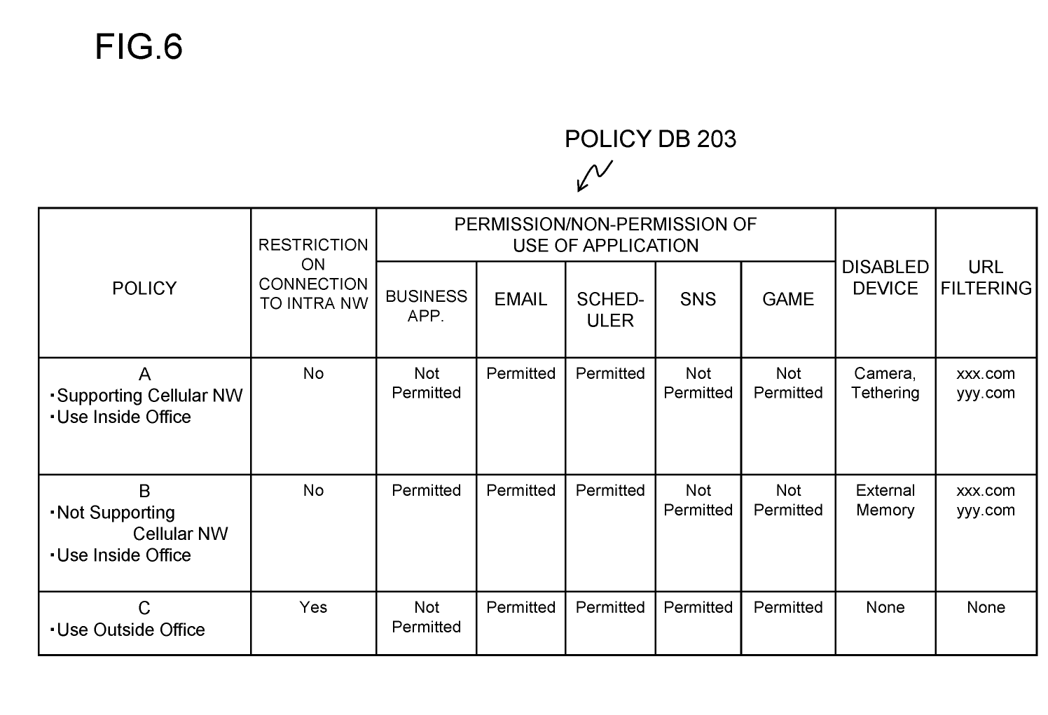

The policy DB 203 illustrated in FIG. 6 stores policy information such as the presence/absence of restriction on connection to an intra-company network and permission/non-permission of the use of an application installed in each terminal.

Referring to FIG. 6, the policy A is a policy that is set when a terminal (here, a mobile telephone) capable of using a cellular network is used inside the office. Since the mobile telephone is used inside the office, there is no restriction on connection to the intra-company network, but it is “not permitted” to access a portal site prepared by the company to use business applications. Moreover, according to the policy A, the use of applications such as email and scheduler is permitted, but the use of SNS (Social Network Service)- and game-related applications is not permitted. Furthermore, since the policy A assumes the use of a mobile telephone inside the office, it is also possible to disable device functions such as camera and tethering and further to set URL filtering to restrict access to a specific website.

The policy B is a policy that is set when a terminal (here, a note PC) incapable of using a cellular network is used inside the office. The policy B is similar to the policy A in settings with respect to email, scheduler, SNS, game and the like, but is different from the policy A in that the use of business applications is permitted as long as a user is located inside the office. Moreover, for a disabled device, it is also possible to disable an external memory such as a USB memory.

A policy C is a policy that is set on a terminal when a user is located outside the office, and can be set regardless of the type of a terminal—mobile telephone, note PC or whatever. Since the policy C is for the case where a user is located outside the office, the use of business applications is “not permitted”, the use of SNS and game is “permitted”, and further both disabled device functions and URL filtering are set to “None”.

### <Other Example of User Information Database>

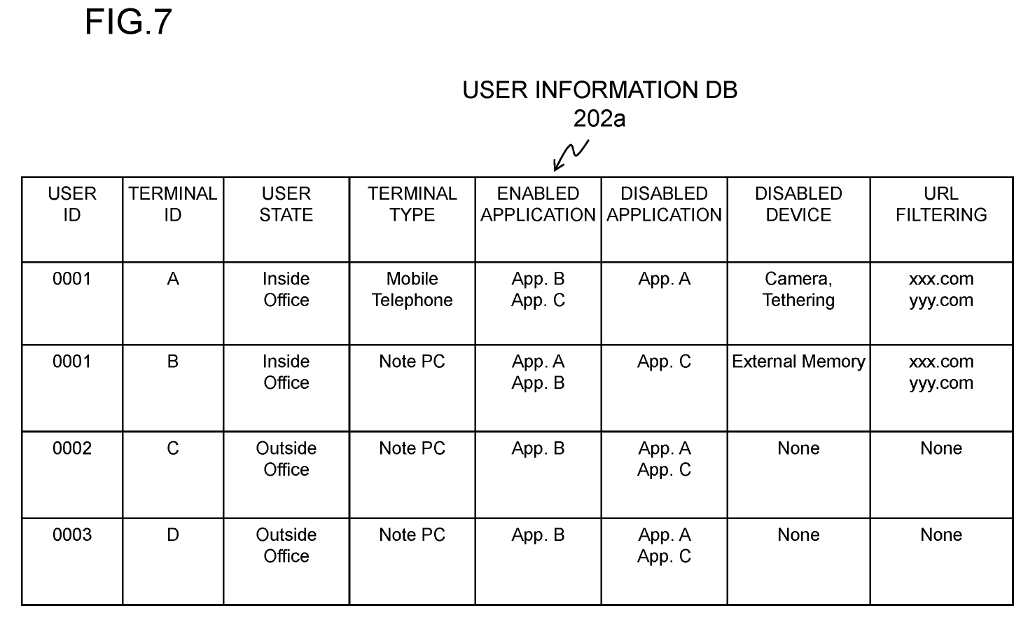

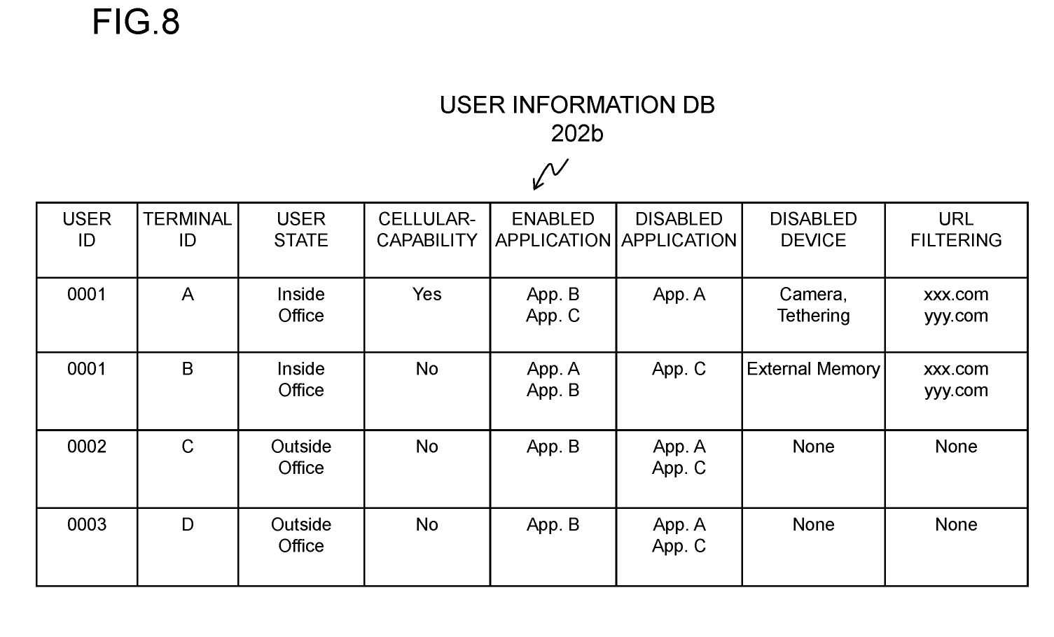

The above-described example illustrates a case where a policy stored in the policy DB 203 is set on a terminal. However, it is also possible to use a user information DB to perform finer BYOD management per privately owned terminal. Hereinafter, a description will be given with reference to FIGS. 7 and 8.

A user information DB 202a stores information for managing restriction on the use of applications, devices and the like for each terminal, as illustrated in FIG. 7. For example, the terminal A (terminal ID=A) owned by the user 0001 can use applications B and C but cannot use an application A. Moreover, the use of device functions such as camera and tethering and access to specific websites are disabled. As described above, the information stored in the user information DB 202a is basically similar to the user information shown in FIGS. 4 and 5, with the addition of the policy information shown in FIG. 6.

Moreover, as shown in FIG. 8, “TERMINAL TYPE” in FIG. 7 may be stored as information (cellular capability) on whether or not a terminal is capable of using a cellular network. Information other than the information on whether or not a terminal supports a cellular network is similar to those of FIG. 7, and therefore a detailed description thereof will be omitted.

### 1.3) Policy Settings

Examples of policy settings including the above-described policy settings are listed below.

Restriction on the Use of Application

Restriction on the use of an application can be set based on a black list method, in which a disabled application is set, or a white list method, in which an enabled application is set.

Temporal Restriction

Temporal restrictions such as a time to deliver an application, a time to execute an application, and the like can be set on a terminal beforehand.

Restriction on the Delivery of File

With respect to files to be delivered to terminals, a file type or the like that is allowed to be received by a terminal can be set to determine whether or not the terminal is allowed to receive a file.

Restriction on the Operation of Terminal/Initialization of Data

It is possible to instruct and cause a terminal to set a remote lock or local lock, which brings the terminal into an inoperable state (locked), and/or to perform remote wipe for initializing, or local wipe for deleting, data in the terminal.

Device Control

It is possible to enable or disable a device function included in a terminal. Examples of a device function include camera, near field communication such as Bluetooth™, wireless LAN interface, external memory, tethering function, screen capture function and the like.

Restriction on Telephone Call Destination

In case where a terminal has a call function, it is possible to restrict telephone call destinations. For example, when a terminal is used in business, it is possible to limit the call destinations to which the terminal can make phone calls only to those related to business.

URL Filtering

When a terminal is used to browse the Internet, it is possible to set a URL that can be browsed, or to set a URL that cannot be browsed.

Virus Scanning/Malware Scanning

It is possible to set a terminal to scan for viruses, malware and the like. At that time, for example, it is also possible to set a time to perform scanning on the terminal.

Home Screen Switching Based on Mode/Policy

It is possible to set a terminal to switch its home screen based on a set mode/policy. For example, when a policy to be set during use in business is set, it is possible to display only applications for use in business. Conversely, when a policy to be set outside working hours is set, the terminal can be set not to display the applications for use in business.

### 1.4) Operation

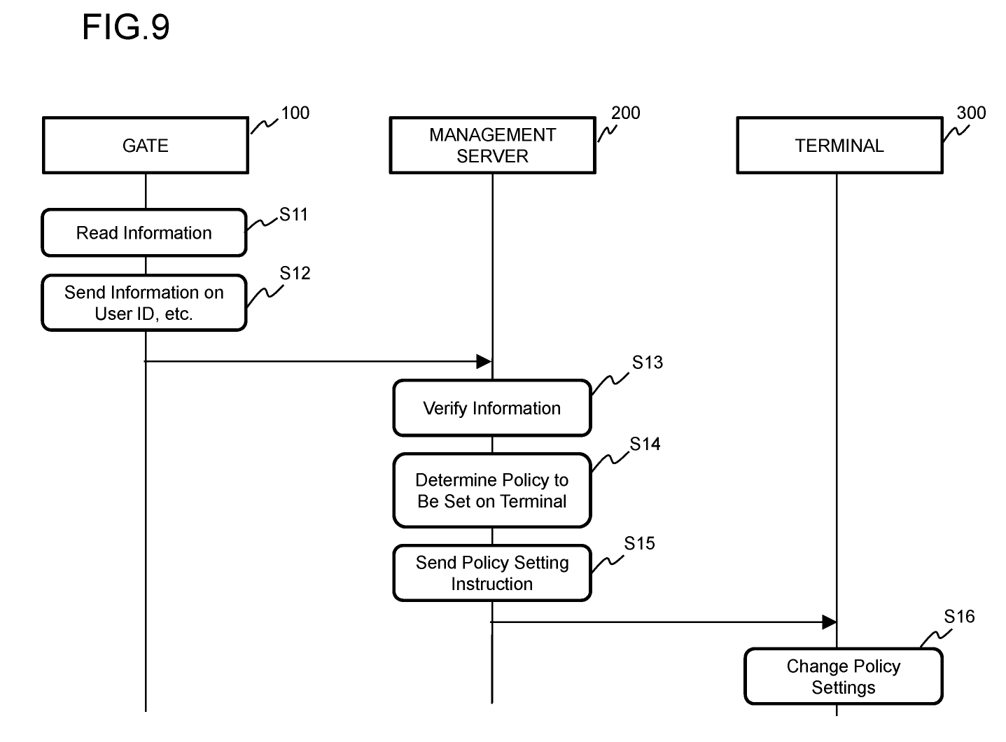

Hereinafter, operations in the management system according to the first exemplary embodiment of the present invention will be described with reference to FIGS. 9 to 11. However, for simplicity of the description, policies to be set on the terminal 300 are limited to two “inside office” and “private” policies. The “inside office” policy is a policy to be set on the terminal 300 when it is determined that the user 400 owning the terminal 300 is located inside the office. Moreover, the “private” policy is a policy to be set on the terminal 300 when it is determined that the user owning the terminal 300 is located outside the office. Note that not only the two policies but policies can be created in actuality by combining various controls such as restriction on the use of applications, devices and the like as described above.

Referring to FIG. 9, first, when a user enters or leaves the office, the user brings an IC card such as an employee ID card closer to, or touches the IC card onto, the gate 100, whereby the gate 100 reads information from the user's IC card (Operation S11). Information read by the gate 100 includes, for example, user ID. Moreover, the gate 100 recognizes that the state of the user is “inside office” when the user enters the office, or recognizes that the state of the user is “outside office” when the user leaves the office. It is also possible to further perform opening/closing of the gate, unlocking of the door, and the like based on a result of user authentication performed by the gate 100.

Subsequently, the gate 100 sends the read information (user ID) and the state of the user (inside office or outside office), which has been changed upon the user's passing the gate 100, to the management server 200 (Operation S12).

The management server 200, when receiving the user information from the gate 100, first searches the user information DB 202 to check whether or not this user is registered with the user information DB 202 (Operation S13). When it is found as a result of the search that the user is not registered with the user information DB 202, it is determined that this user is not permitted BYOD, and no particular policy settings are made on the terminal owned by the user.

When this user is registered with the user information DB 202, the terminal owned by the user is identified, and the state of the user is changed. Thereafter, a policy to be set on the terminal owned by the user is determined based on the state of the user (inside office/outside office), the type of the terminal (supporting/non-supporting cellular network), and the like (Operation S14), and an instruction to set this policy is sent to the terminal 300 (Operation S15). The terminal 300, when receiving this instruction to change the policy settings, changes the policy settings as instructed (Operation S16). This setting change is performed by using, for example, client software or the like preinstalled in the terminal 300. Note that it is also possible that the management server 200 directly change the policy of the terminal 300.

A method for sending the policy setting instruction from the management server 200 to the terminal 300 may differ depending on the type of the terminal, capability/incapability of connecting to a cellular network, or the like. Examples of the method include a method utilizing SMS (Short Message Service) to send a policy, a method utilizing a push server to send a policy to the terminal 300, and the like, which will be described in other exemplary embodiments below.

<In Case of Moving from Inside to Outside of Office>

Hereinafter, a description will be given by taking a case as an example where a user owning terminals A and B is registered with the user information DB 202 as user ID=0001 (hereinafter, referred to as the “user 0001”), and this user 0001 passes the gate 100 and moves from the inside to the outside of the office.

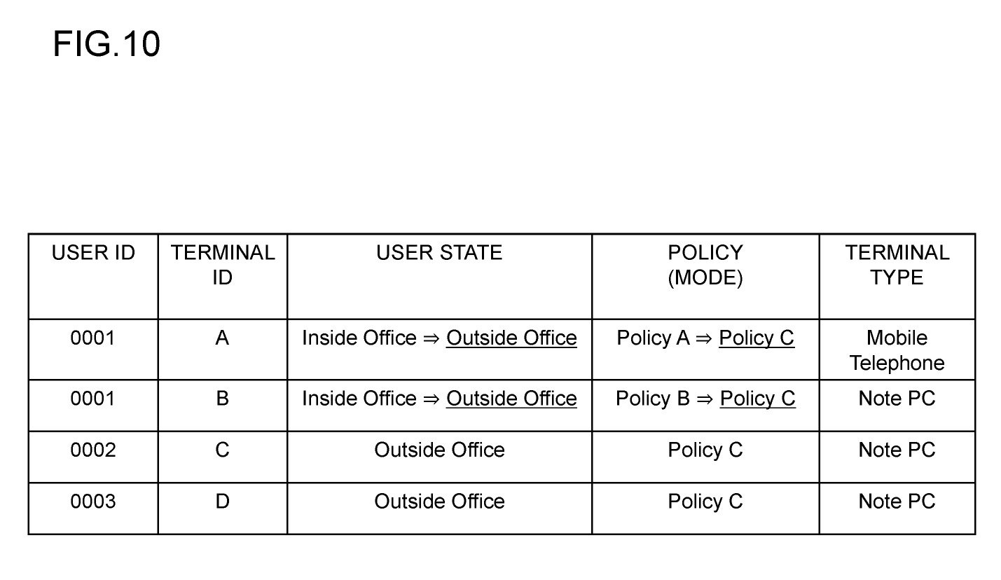

As shown in FIG. 10, since the user 0001 is registered with the user information DB 202, the management server 200 searches the user information DB 202 and identifies the user 0001 (Operation S13). Subsequently, the management server 200 changes the state of the user 0001 from “inside office” to “outside office”, then further searches the policy DB 203, and changes the policy applied to the terminals A and B of the user 0001 in the user information DB 202 from the “inside office” policy A to the “outside office” policy C (Operation S14). Since the move in this case is a move to the outside of the office, the policy C is applied regardless of the types of the terminals. Then, the management server 200 sends an instruction to set this policy C to the terminals A and B (Operation S15), and the terminals A and B having received this instruction to change the policy settings change their own operation to follow the policy C, which is applied to terminals located outside the office (Operation S16).

<In Case of Moving from Outside to Inside of Office>

Next, a description will be given by taking a case as an example where a user owning a terminal C is registered with the user information DB 202 as user ID=0002 (hereinafter, referred to as the “user 0002”), and this user 0002 passes the gate 100 and moves from the outside to the inside of the office.

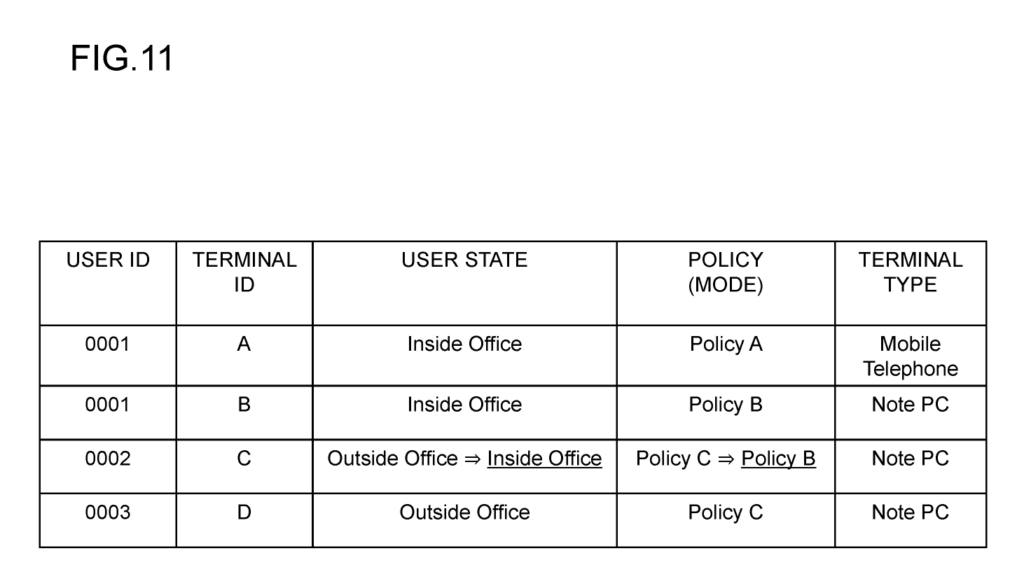

As shown in FIG. 11, since the user 0002 is registered with the user information DB 202, the management server 200 searches the user information DB 202 and identifies the user 0002 (Operation S13). Subsequently, the management server 200 changes the state of the user 0002 from “outside office” to “inside office”, then further searches the policy DB 203, and changes the policy applied to the terminal C of the user 0002 in the user information DB 202 from the “outside office” policy C to the “inside office” policy B (Operation S14). Since the move of the terminal B in this case is a move of a note PC incapable of using a cellular network to the inside of the office, the policy set inside the office is the policy B, as described with FIG. 6. Then, the management server 200 sends an instruction to set this policy B to the terminal C (Operation S15), and the terminal C having received this instruction to change the policy settings changes its own operation to follow the policy B (Operation S16).

### 1.5) Effects

As described above, according to the first exemplary embodiment of the present invention, the gate 100, which is an existing user's entrance/exit determination device, and the management server 200 for managing terminals are configured to operate in cooperation with each other, whereby it is unnecessary to provide a terminal with a special function such as a contactless employee ID card. Accordingly, even a privately owned terminal that generally does not support contactless authentication such as a note PC can be easily used in business, and consequently BYOD usage can be promoted.

Moreover, a system for managing the use of a terminal in business and the terminal are separated, whereby the advantage is obtained that the range of management targets of the management system and the type of management for each terminal can be flexibly determined.

### 2. Second Exemplary Embodiment

Next, as a second exemplary embodiment of the present invention, a description will be given of a management system in which a policy setting instruction is made to a terminal capable of using a cellular network. The internal configurations of a management server and a terminal are basically similar to the configurations shown in FIGS. 2 and 3, and therefore a description thereof will be omitted. A description will be given mainly of operations different from those of the first exemplary embodiment. A terminal capable of using a cellular network corresponds to a terminal denoted with “mobile telephone” under “TERMINAL TYPE” shown in FIG. 4, or a terminal denoted with “Yes” under “CELLULAR-CAPABILITY” shown in FIG. 5. Specifically, for example, it is a mobile telephone, a mobile terminal or the like that can access 3G or LTE, as described in the first exemplary embodiment.

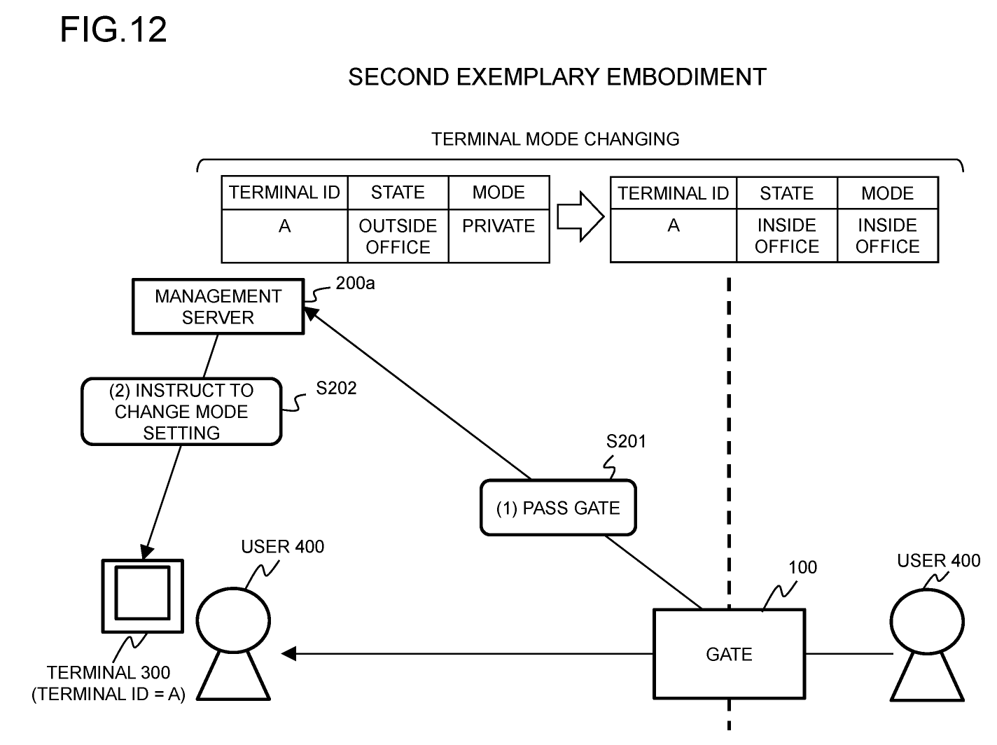

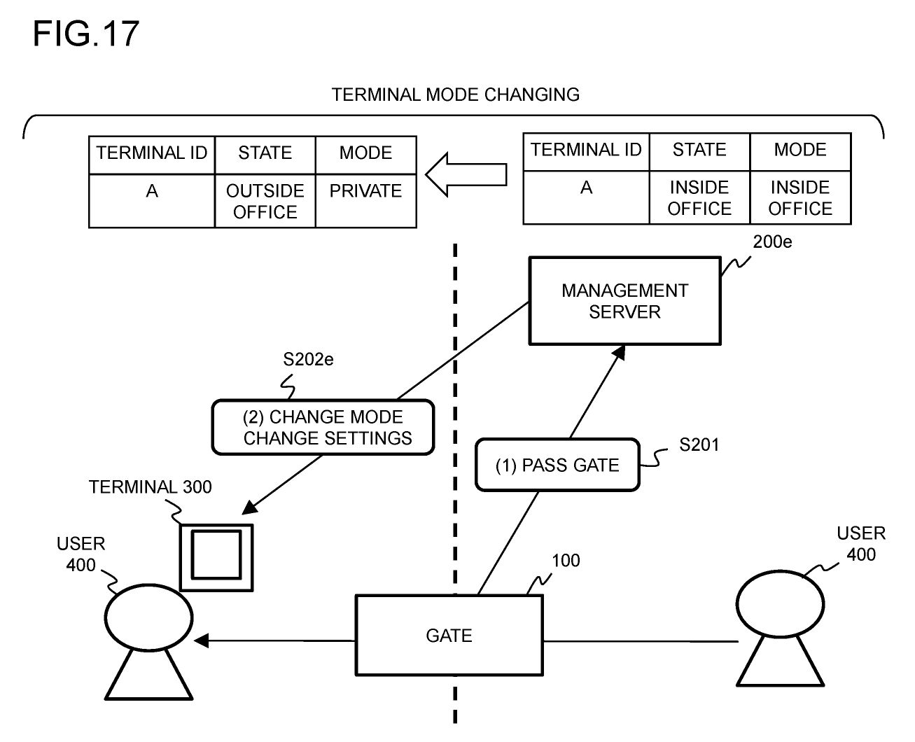

Moreover, it is assumed that terminals are previously registered with the management server. With respect to policies, it is assumed to employ the “inside office” and “private” policies based on the terminal types illustrated in FIG. 6, as in the first exemplary embodiment. Hereinafter, a description will be given of roughly divided cases where a user moves from the outside to the inside of the office (FIGS. 12 to 16), and where a user moves from the inside to the outside of the office (FIGS. 17 to 21), assuming that the same reference numbers as in FIG. 1 are given to the same components as those of the first exemplary embodiment.

### 2.1) Example I of Mode Changing Through Push Communication

The management server, when detecting that a user has passed the gate, directly instructs a terminal owned by the user to change the mode from “outside office” to “inside office”.

Referring to FIG. 12, when the user 400 holds, for example, a contactless employee ID card or the like over and passes the gate 100, identification information and the like of the user 400 is notified from the gate 100 to a management server 200a as described already (Operation S201). Upon this notification of a move of the user 400 to the inside of the office, the management server 200a sends an instruction to the terminal 300 of terminal ID=A, which is privately owned by the user 400, to change the policy set on the terminal 300 to a mode for the use inside the office (Operation S202). Thereby, each of the user state information and mode information for the terminal A stored in the user information DB 202 is updated to “inside office”, as shown at the top of FIG. 12.

The terminal 300 having received the instruction to change the mode setting changes the set policy from “private” to “inside office”. Policy information to be set may be stored in the terminal 300 beforehand and changed in response to an instruction to change the mode setting, or policy information itself may be received from the management server 200a. Here, since the terminal 300 is capable of using a cellular network, the setting is changed, for example, from the policy C to the policy A shown in FIG. 6. However, the policies shown in FIG. 6 are examples, and policies can be created by combining various controls such as restriction on the use of applications, devices and the like, as described in the first exemplary embodiment.

### 2.2) Example II of Mode Changing Through Push Communication

The management server, when detecting that a user has passed the gate, sends an instruction to change the mode or an instruction to set a mode to a relevant terminal via an SMS server.

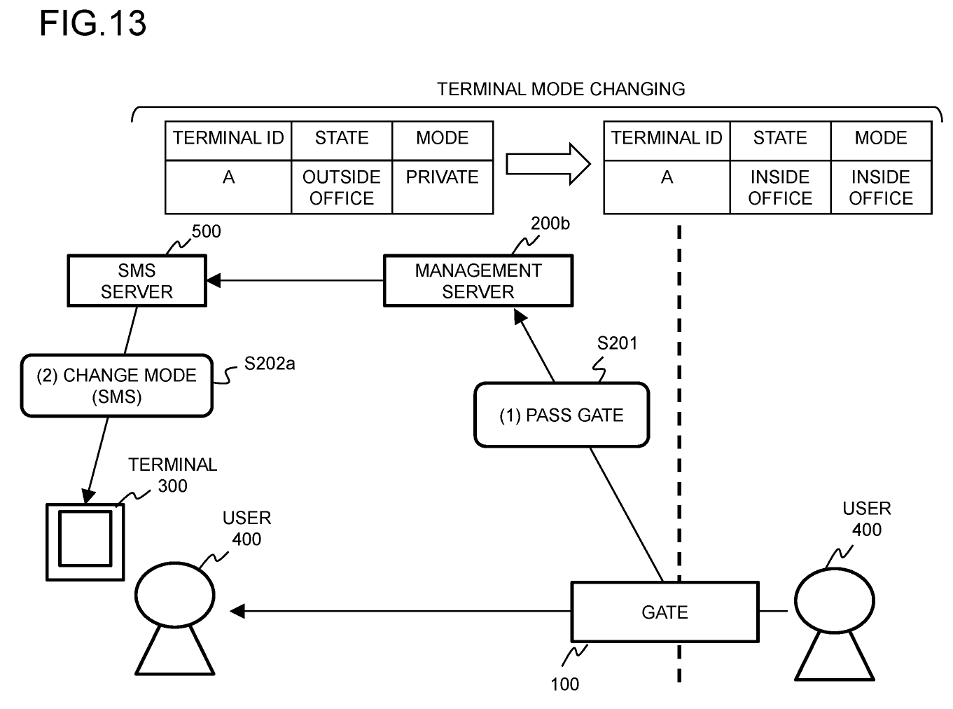

A management system shown in FIG. 13 includes an SMS server 500 in addition to the system architecture shown in FIG. 12. The SMS server 500 is, for example, a server owned by a communication carrier and can send an SMS to a terminal under contract with the carrier.

Referring to FIG. 13, when the user 400 holds, for example, a contactless employee ID card or the like over and passes the gate 100, identification information and the like of the user 400 is notified from the gate 100 to a management server 200b as described already (Operation S201). The management server 200b instructs the SMS server 500 to send a message to the terminal 300 of terminal ID=A, which is privately owned by the user 400, to change the policy set on the terminal 300 to a mode for the use inside the office. Thereby, the SMS server 500 sends an SMS for instructing to change to this mode to the terminal 300 (Operation S202a). At the management server 200b, each of the user state information and mode information for the terminal A stored in the user information DB 202 is updated to “inside office”, as shown at the top of FIG. 13.

The terminal 300 having received the SMS for instructing to change the mode setting analyzes the SMS and changes the set policy from “private” to “inside office”. It is also possible that policy information to be set is stored in the terminal 300 beforehand and changed in response to an instruction to change the mode setting. Here, since the terminal 300 is capable of using a cellular network, the setting is changed, for example, from the policy C to the policy A shown in FIG. 6.

### 2.3) Example III of Mode Changing Through Push Communication

The management server, when detecting that a user has passed the gate, sends an instruction to change the mode or an instruction to set a mode to a relevant terminal via a push server. The push server may be installed either inside or outside the office and may be a server owned by the company the user 400 belongs to.

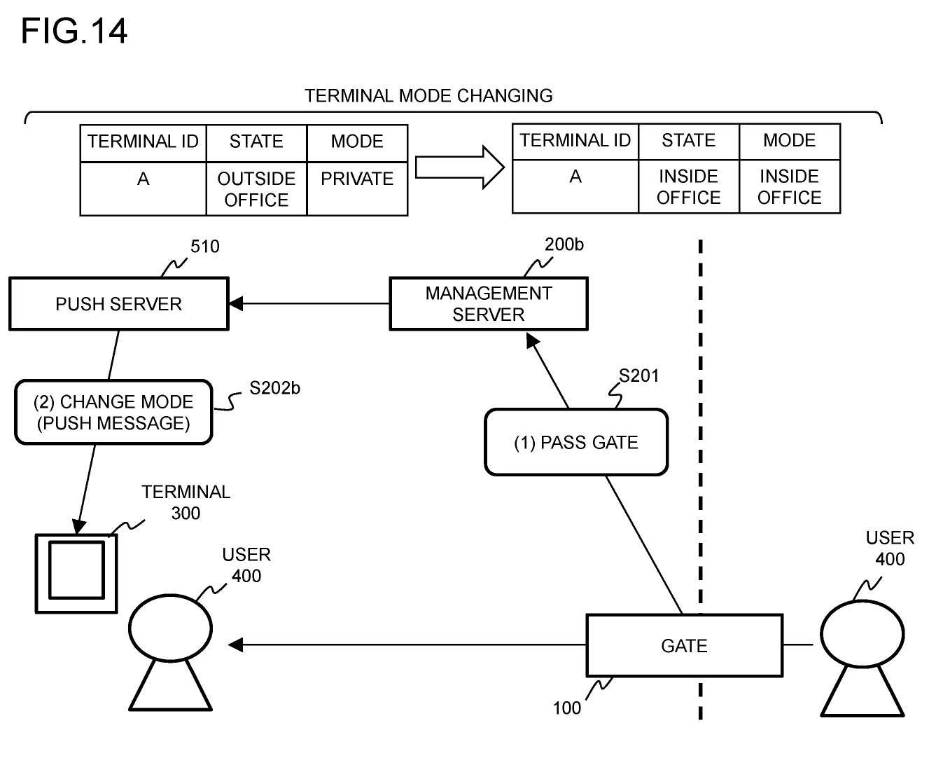

A management system shown in FIG. 14 has an architecture in which a push server 510 is deployed in place of the SMS server 500 in the system shown in FIG. 13. The push server 510 only needs to be a server having a function of sending a message to the terminal 300. In the example of FIG. 14, the push server 510 can send a push message regarding changing of the mode of, or setting of a policy on, the terminal 300. The system is not greatly different from the system shown in FIG. 13 except that the SMS server 500 is replaced with the push server 510, and therefore a description of the architecture and operation will be omitted.

### 2.4) Example IV of Mode Changing Through Push Communication

The management server, when detecting that a user has passed the gate, requests a relevant terminal to make an authentication request via an SMS server or a push server and, when authentication in response to the authentication request of the terminal is successfully done, instructs this terminal to change the mode or to set a mode.

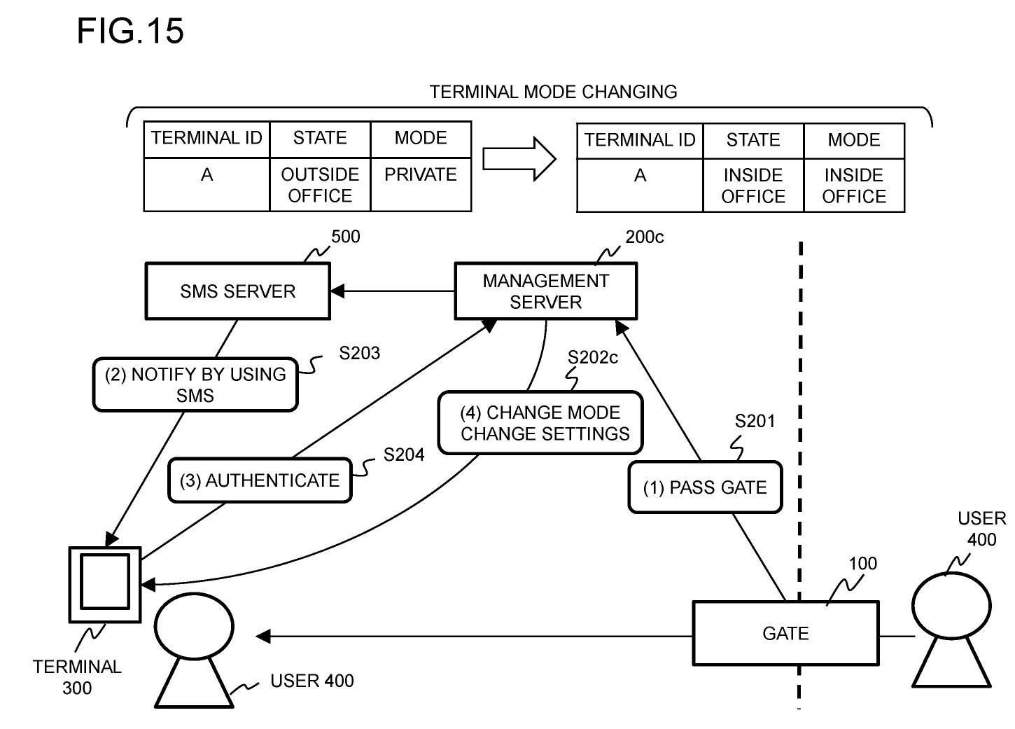

A management system shown in FIG. 15 has a system architecture similar to that shown in FIG. 13 including an SMS server, but the operations of a management server 200c and the terminal 300 are different. First, when the user 400 holds, for example, a contactless employee ID card or the like over and passes the gate 100, identification information and the like of the user 400 is notified from the gate 100 to the management server 200c as described already (Operation S201). The management server 200c requests the SMS server 500 to send an SMS for causing the terminal 300 to request authentication. The SMS server 500 having received this request sends such an SMS to the terminal 300 to request it to go through authentication (Operation S203).

The terminal 300, when receiving the request message from the SMS server 500, makes an authentication request to the management server 200c (Operation S204). When authentication of the terminal 300 is successfully done, the management server 200c instructs the terminal 300 to change the mode of, or to change the policy settings on, the terminal (Operation S202c), whereby the policy of the terminal 300 is changed to an “inside office” policy. Moreover, at the management server 200c, each of the user state information and mode information for the terminal 300 (terminal ID=A) stored in the user information DB 202 is updated to “inside office”, as shown at the top of FIG. 15.

The terminal 300 having received the instruction to change the mode setting changes the set policy from “private” to “inside office”. Policy information to be set may be stored in the terminal 300 beforehand and changed in response to an instruction to change the mode setting, or policy information itself may be received from the management server 200a. Here, since the terminal 300 is capable of using a cellular network, the setting is changed, for example, from the policy C to the policy A shown in FIG. 6.

Note that although a description is given of a case where the SMS server 500 is used in the example shown in FIG. 15, it is also possible to use the push server 510 as described above.

### 2.5) Example of Mode Changing Through Pull Communication

The management server, when receiving a pull communication from a terminal after detecting that a user has passed the gate, authenticates this terminal and thereafter instructs to change the mode or to set a mode. The terminal, triggered by the activation of the client, makes the pull communication to the management server.

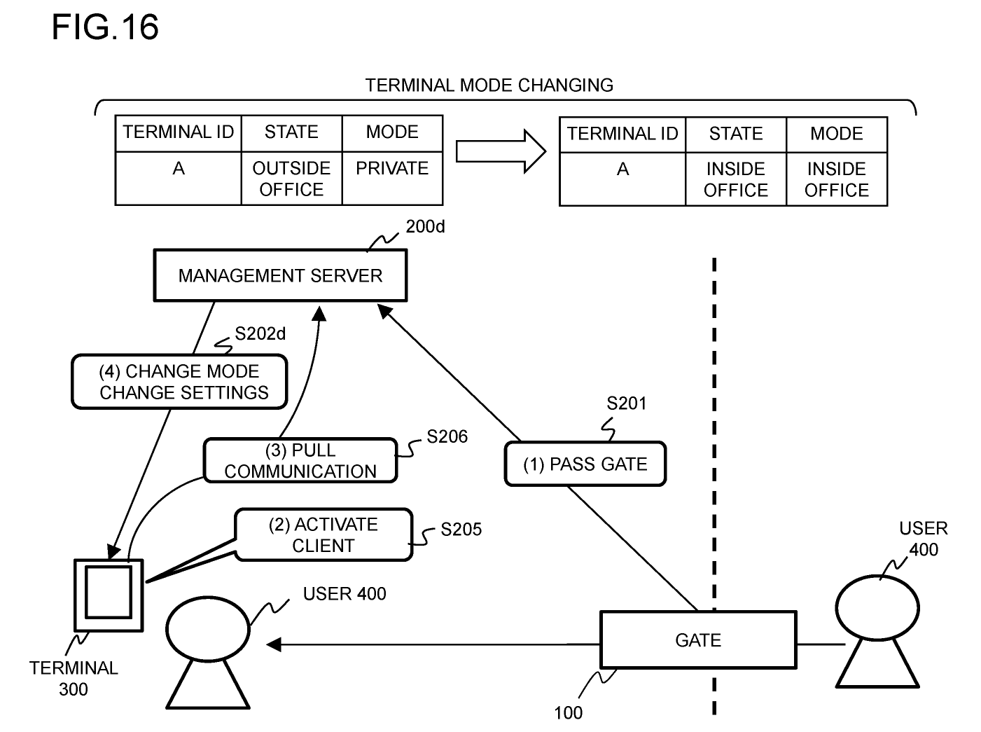

Referring to FIG. 16, when the user 400 holds, for example, a contactless employee ID card or the like over and passes the gate 100, identification information and the like of the user 400 is notified from the gate 100 to a management server 200d as described already (Operation S201). Thereby, the state of the terminal 300 of terminal ID=A, which is owned by the user 400, in the user information DB 202 is updated from “outside office” to “inside office”, and in response to this update, the policy set on the terminal 300 is changed from “private” to “inside office”.

Subsequently, when the client of the terminal 300 is activated (Operation S205), the terminal 300 performs pull communication to the management server 200d (Operation S206). Specifically, the terminal 300 inquires of the management server 200d about whether or not to change the mode setting.

Upon receiving the pull communication from the terminal 300, the management server 200d performs authentication of this terminal 300 and, when authentication is successfully done, instructs the terminal 300 to change the mode or to change the policy settings (Operation S202d). Through the above-described operations, the policy of the terminal 300 is changed to an “inside office” policy.

Note that in the above-described example, pull communication by the terminal 300 is triggered by the activation of the client of the terminal 300, but similar pull communication may be performed when the terminal 300 is turned on.

### 2.6) Example of Mode Changing in Case of Moving from Inside to Outside of Office

Hereinafter, a brief description will be given of an example of mode changing in case of moving to the outside of the office, with reference to FIGS. 17 to 21. Note that the respective system architectures shown in FIGS. 17 to 21 are basically similar to the system architectures shown in FIGS. 12 to 16, with the difference that mode changing operation when a terminal moves to the outside of the office is different. Accordingly, a description of the system architectures will be omitted.

FIG. 17 shows an example of mode changing through push communication corresponding to FIG. 12. A management server 200e, when detecting that the user 400 has passed the gate 100 and gone to the outside of the office (Operation S201), directly instructs the relevant terminal 300 to change to the “outside office” mode (Operation S202e). The instruction from the management server 200e to the terminal 300 can be sent via a cellular network. Thereby, the user state information and mode information for the terminal A stored in the user information DB 202 are updated to “outside office” and “private”, respectively, as shown at the top of FIG. 17.

The terminal 300 having received the instruction to change the mode setting changes the set policy from “inside office” to “private”. Policy information to be set may be stored in the terminal 300 beforehand and changed in response to an instruction to change the mode setting, or policy information itself may be received from the management server 200a. Here, since the terminal 300 is capable of using a cellular network, the setting is changed, for example, from the policy A to the policy C shown in FIG. 6. However, the policies shown in FIG. 6 are examples, and policies can be created by combining various controls such as restriction on the use of applications, devices and the like as described in the first exemplary embodiment.

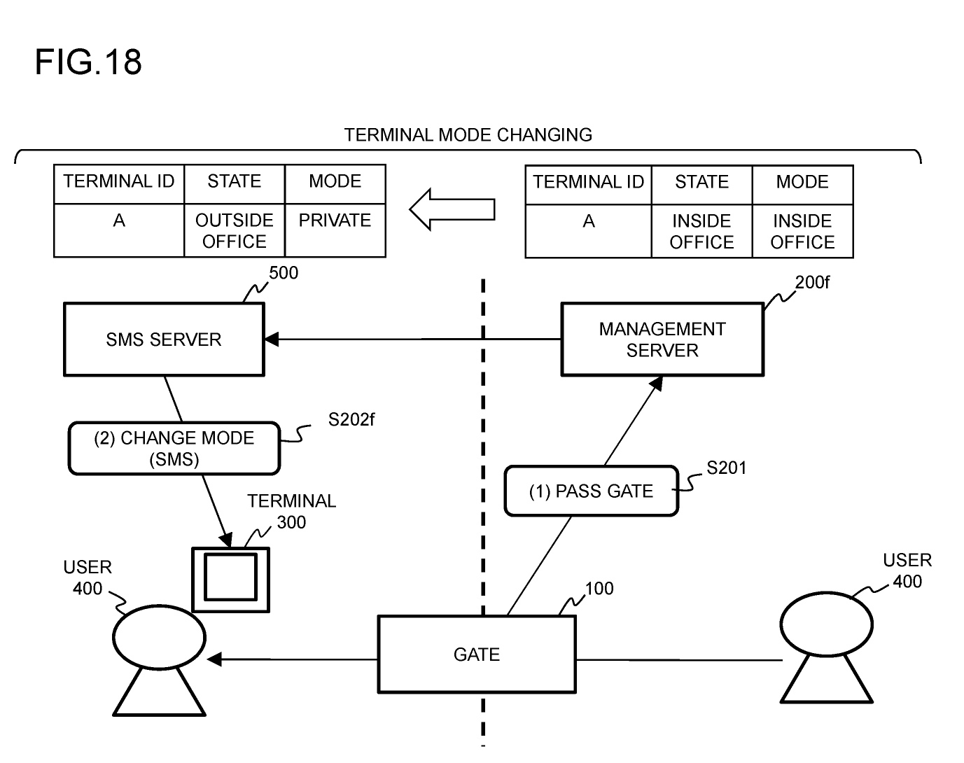

FIG. 18 shows an example of mode changing through push communication corresponding to FIG. 13. A management server 200f, when detecting that the user 400 has passed the gate 100 and gone to the outside of the office (Operation S201), sends a message for instructing to change the mode or for instructing to set a mode to the relevant terminal 300 via the SMS server 500 (Operation S202f). The SMS server 500 is installed outside the office.

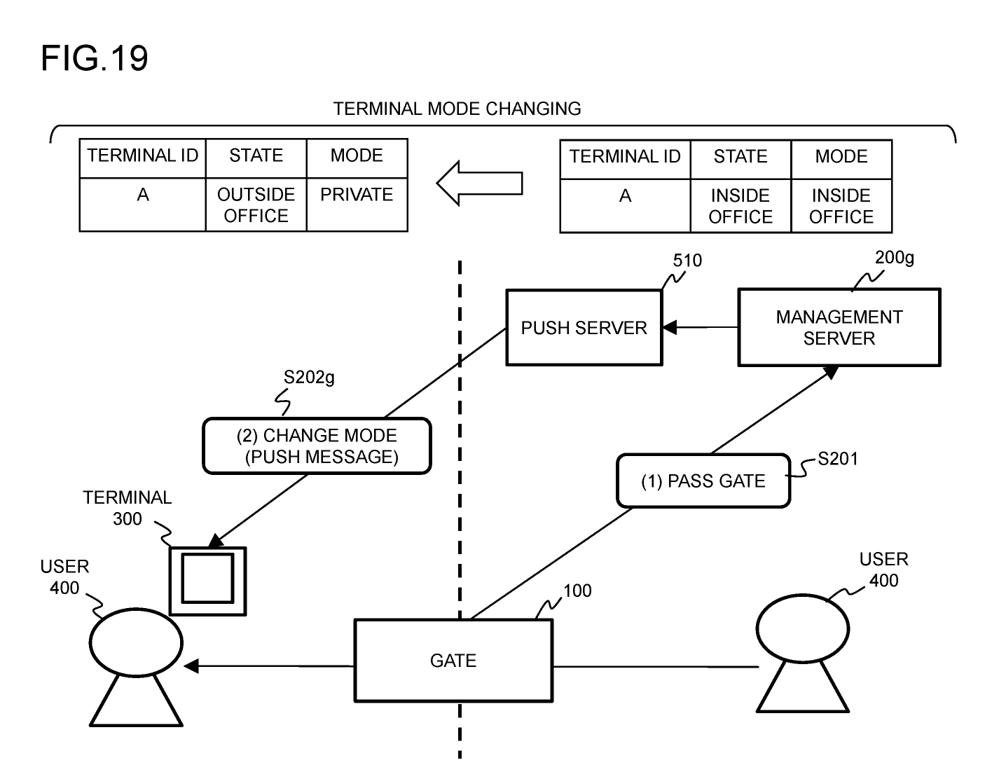

FIG. 19 shows an example of mode changing through push communication corresponding to FIG. 14. A management server 200g, when detecting that the user 400 has passed the gate 100 and gone to the outside of the office (Operation S201), sends a push message indicating mode changing or mode setting to the relevant terminal 300 via the push server 510 (Operation S202g). The push server 510 can be installed either outside or inside the office.

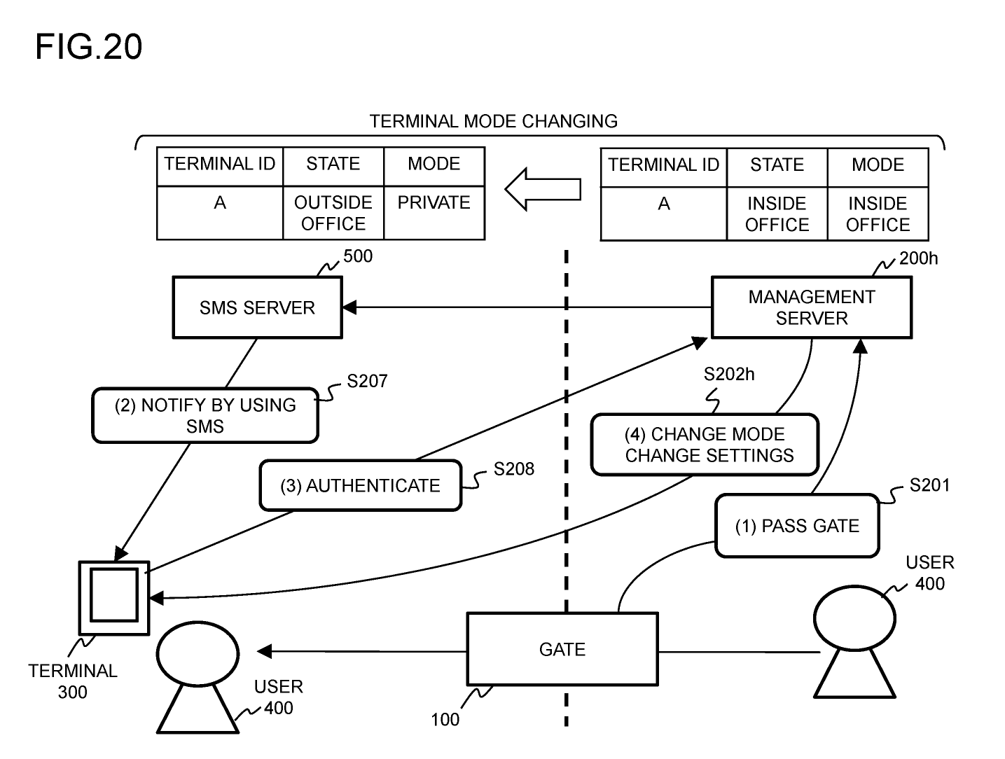

FIG. 20 shows an example of mode changing through push communication corresponding to FIG. 15. A management server 200h, when detecting that the user 400 has passed the gate (Operation S201), sends a message for requesting to make an authentication request to the relevant terminal 300 via the SMS server 500 (or a push server) (Operation S207). When an authentication request is received from the terminal 300 and authentication is successfully done, the management server 210h instructs this terminal 300 to change the mode or to set a mode (Operation S202h).

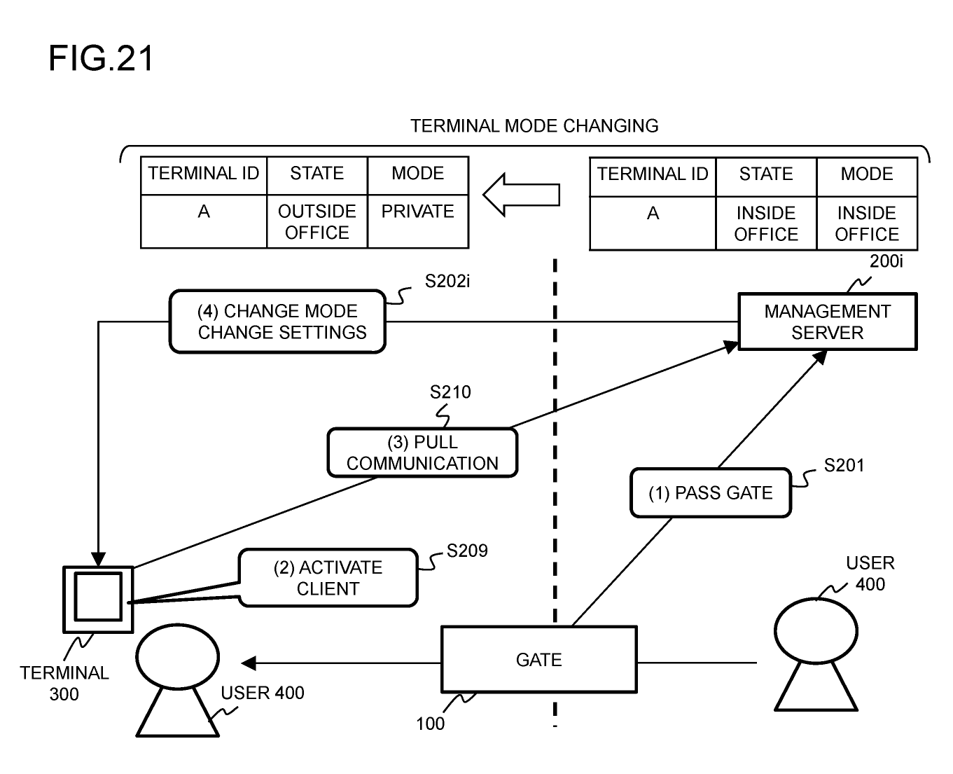

FIG. 21 shows an example of mode changing through pull communication corresponding to FIG. 16. When a management server 200i detects that the user 400 has passed the gate (Operation S201), the management server 200i waits for a pull communication from the terminal 300 thereafter. When the client is activated at the terminal 300 (Operation S209) and a pull communication arrives (Operation S210), the management server 200i instructs the terminal 300 to change the mode or to set a mode after this terminal 300 is authenticated (Operation S202i).

### 3. Third Exemplary Embodiment

Next, as a third exemplary embodiment of the present invention, a description will be given of a management system in which a policy setting instruction is made to a terminal incapable of using a cellular network. The internal configurations of a management server and a terminal are basically similar to the configurations shown in FIGS. 2 and 3, and therefore a description thereof will be omitted. A description will be given mainly of operations different from those of the first exemplary embodiment. A terminal incapable of using a cellular network corresponds to a terminal denoted with “note PC” under “TERMINAL TYPE” shown in FIG. 4, or a terminal denoted with “No” under “CELLULAR-CAPABILITY” shown in FIG. 5. Specifically, for example, it is a note PC, a tablet terminal or the like that has no access function for 3G or LTE, as described in the first exemplary embodiment.

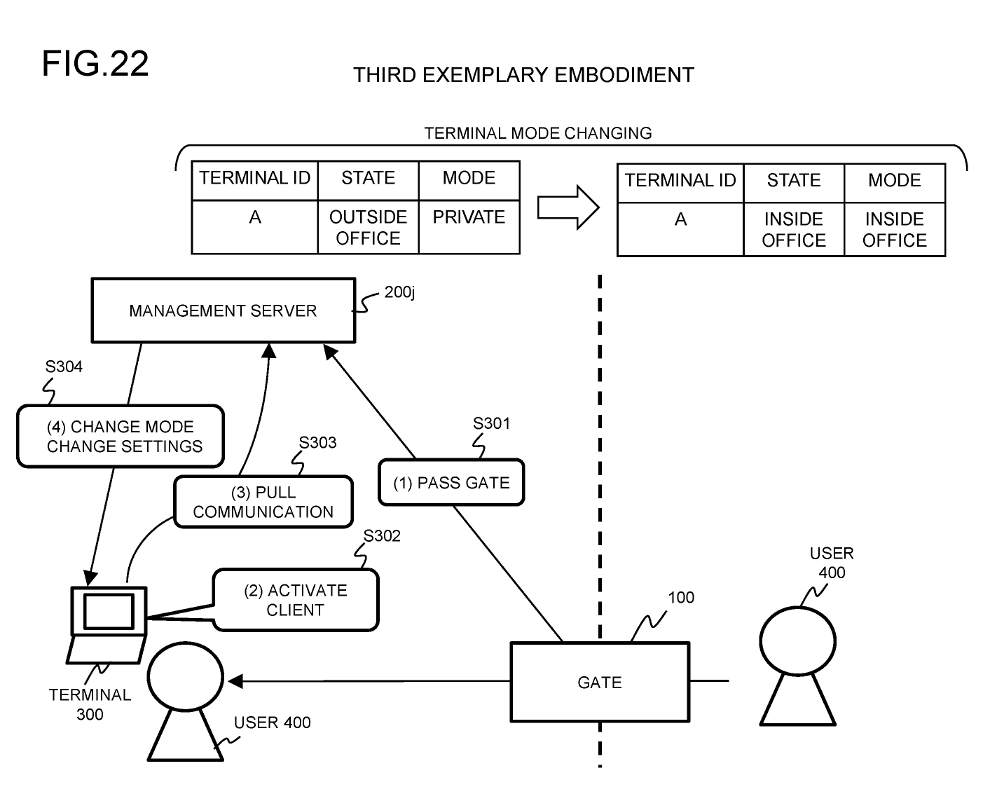

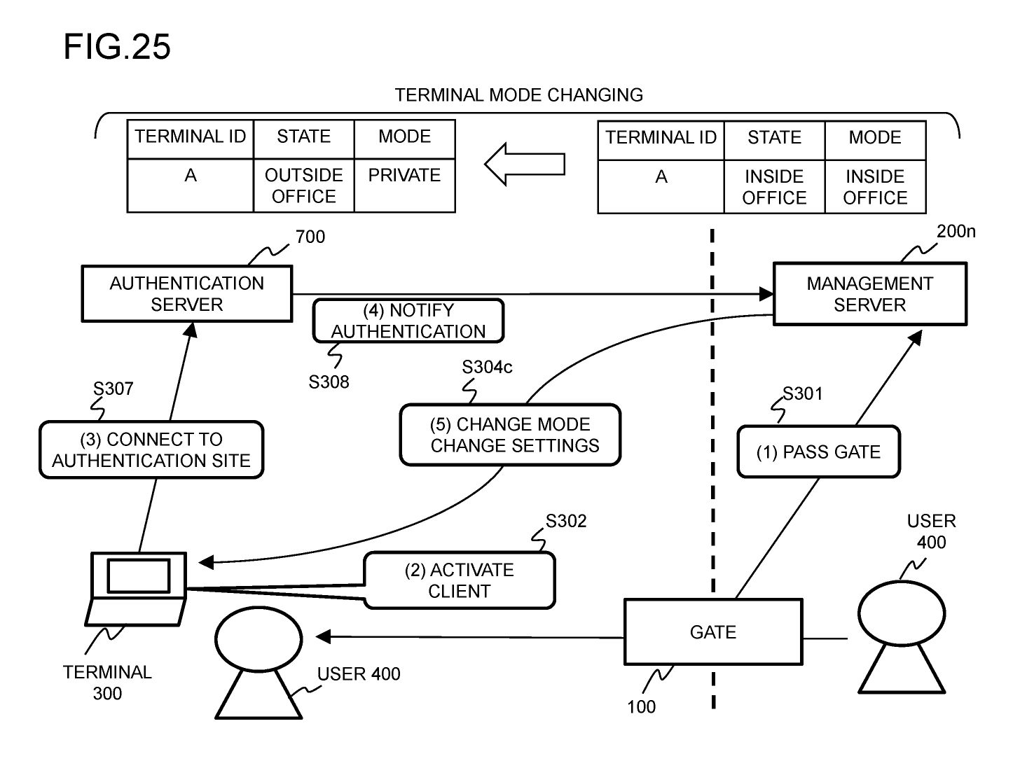

Moreover, it is assumed that terminals are registered with the management server beforehand. With respect to policies, it is assumed to employ the “inside office” and “private” policies based on the terminal types illustrated in FIG. 6, as in the first exemplary embodiment. Hereinafter, a description will be given of roughly divided cases where a user moves from the outside to the inside of the office (FIGS. 22 to 24), and where a user moves from the inside to the outside of the office (FIGS. 25 to 27), assuming that the same reference numbers as in FIG. 1 are given to the same components as those of the first exemplary embodiment.

### 3.1) Example of Mode Changing Through Pull Communication

The management server, when receiving a pull communication from a terminal after detecting that a user has passed the gate, authenticates this terminal and thereafter instructs to change the mode or to set a mode. The terminal, triggered by the activation of the client, makes the pull communication to the management server.

Referring to FIG. 22, when the user 400 holds, for example, a contactless employee ID card or the like over and passes the gate 100, identification information and the like of the user 400 is notified from the gate 100 to a management server 200j as described already (Operation S301). Thereby, the state of the terminal 300 of terminal ID=A, which is owned by the user 400, in the user information DB 202 is updated from “outside office” to “inside office”, and in response to this update, the policy set on the terminal 300 is changed from “private” to “inside office”.

Subsequently, when the client of the terminal 300 is activated (Operation S302), the terminal 300 performs pull communication to the management server 200j (Operation S303). Specifically, the terminal 300 inquires of the management server 200j about whether or not to change the mode setting.

Upon receiving the pull communication from the terminal 300, the management server 200j performs authentication of this terminal 300 and, when authentication is successfully done, instructs the terminal 300 to change the mode or to change the policy settings (Operation S304). Through the above-described operations, the policy of the terminal 300 is changed to an “inside office” policy. Here, since the terminal 300 is a terminal incapable of using a cellular network, the policy is changed from the policy C to the policy B shown in FIG. 6.

Note that in the above-described example, pull communication by the terminal 300 is triggered by the activation of the client of the terminal 300, but similar pull communication may be performed when the terminal 300 is turned on.

### 3.2) Example of Mode Changing Via Intra-Office Access Point

The management server, when receiving a notification of the completion of authentication of a relevant terminal from an intra-office access point after detecting that a user has passed the gate, instructs this terminal to change the mode or to set a mode. The terminal, triggered by the activation of the client, makes a connection request to the intra-office access point.

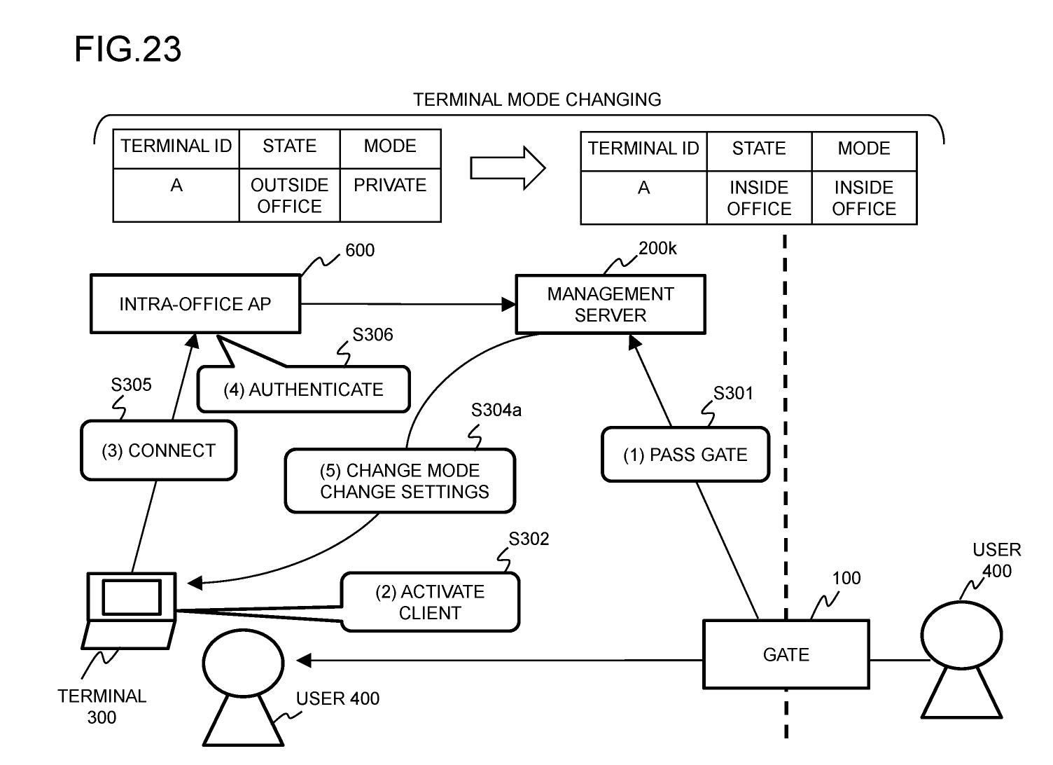

Referring to FIG. 23, when the user 400 holds, for example, a contactless employee ID card or the like over and passes the gate 100, identification information and the like of the user 400 is notified from the gate 100 to a management server 200k as described already (Operation S301). Thereby, the state of the terminal 300 of terminal ID=A, which is owned by the user 400, in the user information DB 202 is updated from “outside office” to “inside office”, and in response to this update, the policy set on the terminal 300 is changed from “private” to “inside office”.

Subsequently, when the client of the terminal 300 is activated (Operation S302), the terminal 300 makes a connection request to an intra-office access point 600 and connects to the intra-office access point 600 (Operation S305). For connection to the intra-office access point 600, it is only necessary to prepare, for example, a dedicated SSID (Service Set Identifier) for setting or an SSID for a guest.

Subsequently, the intra-office access point 600 performs authentication of the connected terminal 300 (Operation S306) and, when authentication is successfully done, sends information on the terminal 300 to the management server 200k. Thereby, the management server 200k instructs the terminal 300, which has passed the gate and has been authenticated, to change the mode or to change the policy settings (Operation S304a). Through the above-described operations, the policy of the terminal 300 is changed to an “inside office” policy. Here, since the terminal 300 is a terminal incapable of using a cellular network, the policy is changed from the policy C to the policy B shown in FIG. 6.

### 3.3) Example of Mode Changing Via Authentication Server

The management server, when receiving a notification of the authentication of a relevant terminal from an authentication server after detecting that a user has passed the gate toward the inside of the office, instructs this terminal to change the mode or to set a mode. The terminal, triggered by the activation of the client, connects to the authentication server.

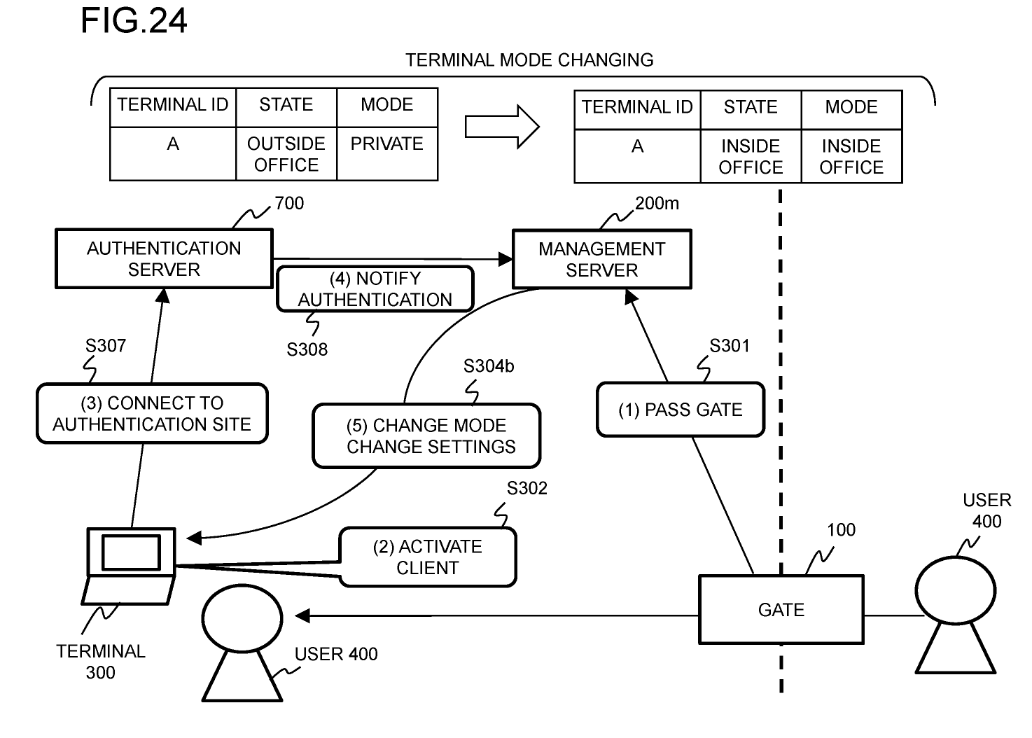

Referring to FIG. 24, when the user 400 holds, for example, a contactless employee ID card or the like over and passes the gate 100, identification information and the like of the user 400 is notified from the gate 100 to a management server 200k as described already (Operation S301). Thereby, the state of the terminal 300 of terminal ID=A, which is owned by the user 400, in the user information DB 202 is updated from “outside office” to “inside office”, and in response to this update, the policy set on the terminal 300 is changed from “private” to “inside office”.

Subsequently, when the client of the terminal 300 is activated (Operation S302), the terminal 300 accesses and connects to an authentication site of an authentication server 700 (Operation S307). Subsequently, the authentication server 700 performs authentication of the connected terminal 300 and, when authentication is successfully done, sends a notification of the authentication of the terminal 300 to the management server 200m (Operation S308). Thereby, the management server 200m instructs this terminal 300 to change the mode or to change the policy settings (Operation S304b). Through the above-described operations, the policy of the terminal 300 is changed to an “inside office” policy. Here, since the terminal 300 is a terminal incapable of using a cellular network, the policy is changed from the policy C to the policy B shown in FIG. 6.

### 3.4) Example I of Mode Changing in Case of Moving from Inside to Outside of Office

The management server, when receiving a notification of the authentication of a relevant terminal from an authentication server after detecting that a user has passed the gate toward the outside of the office, instructs this terminal to change the mode or to set a mode. The terminal, triggered by the activation of the client, connects to the authentication server. It is assumed that this terminal cannot connect to an intra network or to cellular network.

Referring to FIG. 25, when the user 400 holds, for example, a contactless employee ID card or the like over and passes the gate 100 toward the outside of the office, identification information and the like of the user 400 is notified from the gate 100 to a management server 200n as described already (Operation S301). Thereby, the state of the terminal 300 of terminal ID=A, which is owned by the user 400, in the user information DB 202 is updated from “inside office” to “outside office”, and in response to this update, the policy set on the terminal 300 is changed from “inside office” to “private”.

Subsequently, when the client of the terminal 300 is activated (Operation S302), the terminal 300 accesses and connects to the authentication site of the authentication server 700 (Operation S307). Subsequently, the authentication server 700 performs authentication of the connected terminal 300 and, when authentication is successfully done, sends a notification of the authentication of the terminal 300 to the management server 200n (Operation S308). Thereby, the management server 200n instructs this terminal 300 to change the mode or to change the policy settings (Operation S304c). Through the above-described operations, the policy of the terminal 300 is changed to the “private” policy. Here, since the terminal 300 is a terminal incapable of using a cellular network, the policy is changed from the policy B to the policy C shown in FIG. 6.

### 3.5) Example II of Mode Changing in Case of Moving from Inside to Outside of Office

Changing of the mode of a terminal is not determined by the management server, but when the terminal passes the gate and comes to fail to detect an intra-office access point, the terminal itself determines that it has come to the outside of the office and then changes the policy from “inside office” to “private”.

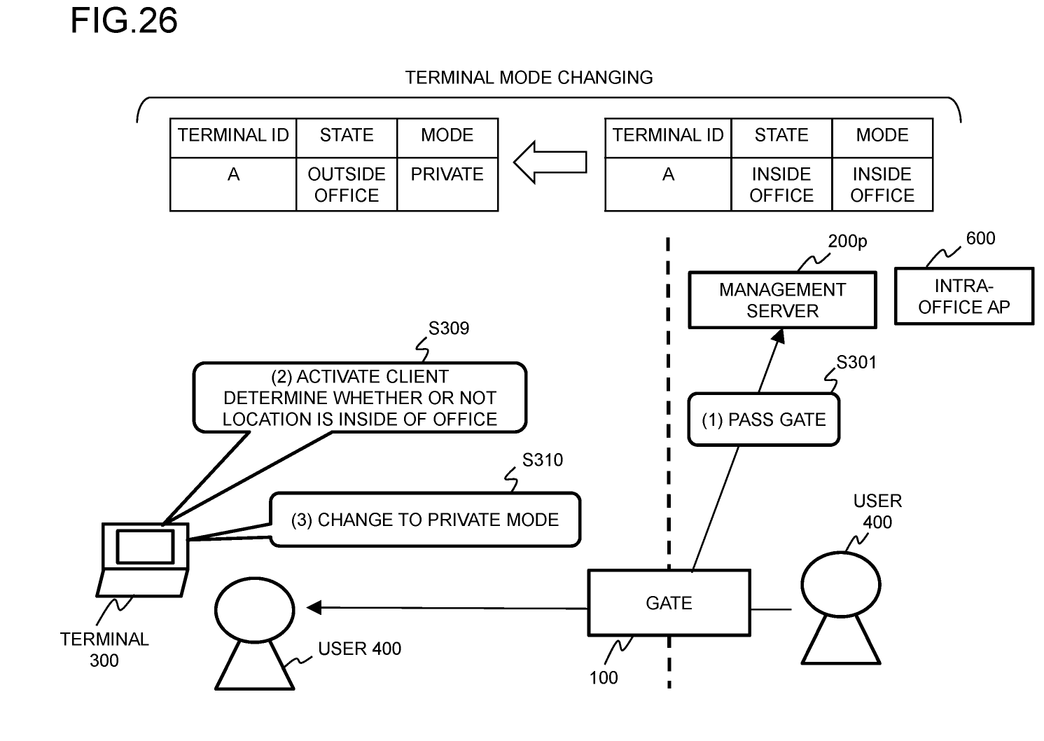

Referring to FIG. 26, when the user 400 holds, for example, a contactless employee ID card or the like over and passes the gate 100, identification information and the like of the user 400 is notified from the gate 100 to a management server 200p as described already (Operation S301). However, the management server 200p is not involved in changing of the mode of the terminal 300.

Subsequently, when the client of the terminal 300 is activated (Operation S309), the terminal 300 determines whether or not it can detect an SSID from the intra-office access point 600 (Operation S309). When such an SSID cannot be detected, the terminal 300 determines that it has come to the outside of the office and changes its own policy to the private mode (Operation S310). Here, since the terminal 300 is a terminal incapable of using a cellular network, the policy of the terminal 300 is changed from the policy B to the policy C shown in FIG. 6. The activation of the client of the terminal 300 may be automatically performed at predetermined cycles, or the client of the terminal 300 may be activated by the user 400.

### 3.6) Example III of Mode Changing in Case of Moving from Inside to Outside of Office

In an example III of mode changing, changing of the mode of a terminal is not determined by the management server, but the terminal itself changes the policy from “inside office” to “private”, as in the above-described example II of mode changing. However, the difference is that the determination criterion is a temporal criterion—whether or not it is a time falling within a predetermined working time range.

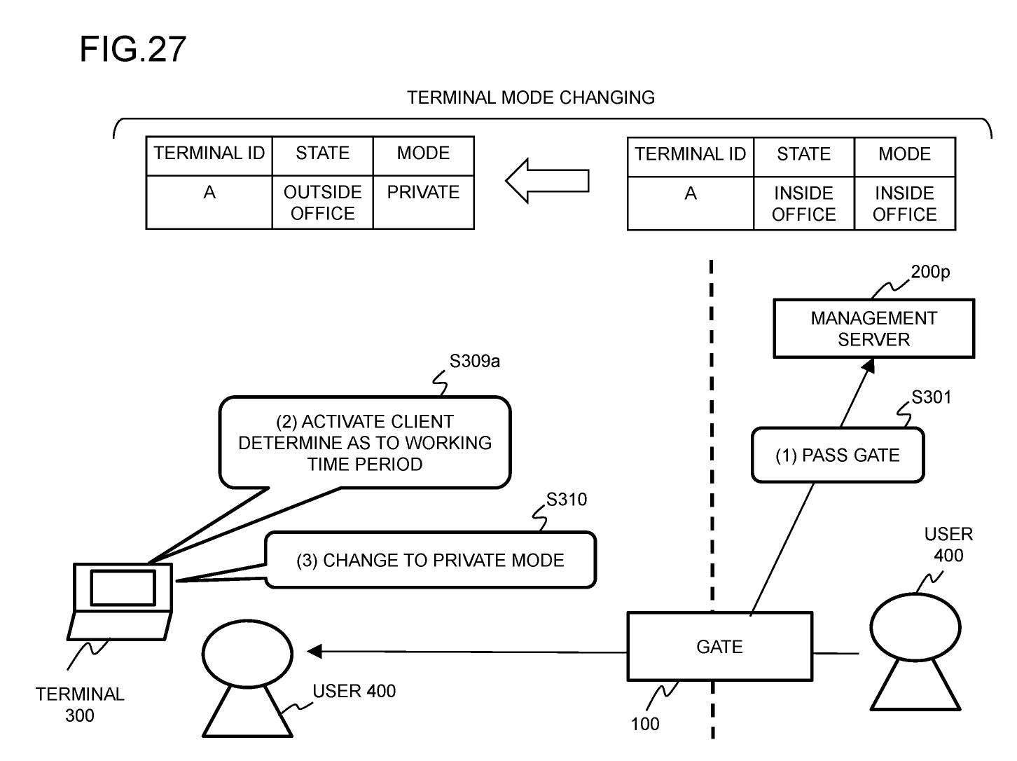

Referring to FIG. 27, when the user 400 holds, for example, a contactless employee ID card or the like over and passes the gate 100, identification information and the like of the user 400 is notified from the gate 100 to the management server 200p as described already (Operation S301). However, the management server 200p is not involved in changing of the mode of the terminal 300.

Subsequently, when the client of the terminal 300 is activated (Operation S309a), the terminal 300 determines whether or not the current time falls within a predetermined working time range (Operation S309a). When the current time is out of the working time range, the terminal 300 determines that it has come to the outside of the office and changes its own policy to the private mode (Operation S310). Here, since the terminal 300 is a terminal incapable of using a cellular network, the policy of the terminal 300 is changed from the policy B to the policy C shown in FIG. 6.

When the current time falls within the working time range, for example, the mode for business (policy B) is kept as it is, and connection can be made to the intra network via the authentication site as described with FIG. 25.

### 4. Fourth Exemplary Embodiment

According to a fourth exemplary embodiment of the present invention, when a user owning a plurality of terminals passes a gate and comes to, for example, the inside or outside of the office, a management server, for each terminal, changes policy settings to adapt to the use inside or outside the office, or the use within or out of a predetermined time range. Examples of the policy settings adequate to the use inside the office include restriction on the use of a device such as a camera mounted on the terminal, restriction on the use of a specific application, and the like, as described in the first exemplary embodiment. Moreover, examples of the policy settings adequate to the use outside the office include restriction on the use of a business application, disabled access to business data, and the like. Further, it is also possible to set different policies not only depending on the location inside/outside the office but also depending on the capability/incapability for a cellular network.

As described above, upon a user's passing the gate, the management server can set adequate policies on a plurality of terminals owned by the user, respectively, depending on the location of the user, the current time and/or the capability/incapability for a cellular network. The plurality of terminals owned by the user need not be carried by the user. For example, even when one of the terminals is carried by the user and the other one is left in the office, the management server can set adequate policies on them, respectively.

In the present exemplary embodiment as well, a case of application to an office of a company will be described similarly to the above-described exemplary embodiments. However, the present exemplary embodiment is not limited to such a case. For example, the present exemplary embodiment can be applied to not only companies but also schools and the like. Hereinafter, a management system and a management server according to the fourth exemplary embodiment will be described in detail with reference to drawings. However, the internal configurations of the management server and a terminal are basically similar to the configurations shown in FIGS. 2 and 3, and therefore a description will be given mainly of operations different from those of the first exemplary embodiment.

### 4.1) System Architecture

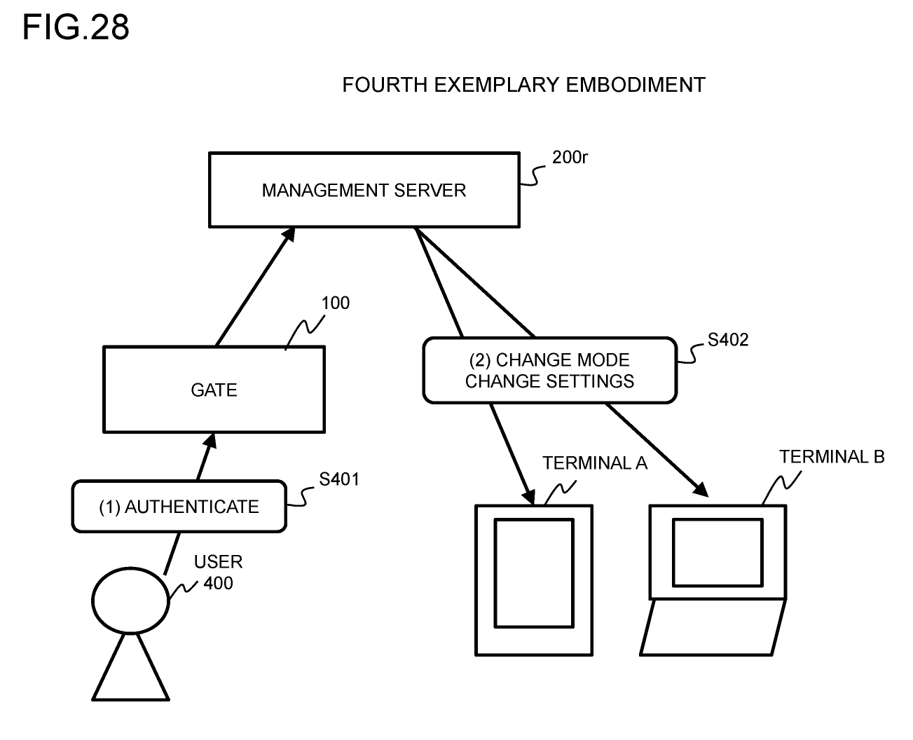

Referring to FIG. 28, it is assumed that the management system according to the present exemplary embodiment includes a gate 100, a management server 200r, and terminals A and B owned by a user 400. Here, it is assumed as an example that the user 400 passes the gate 100 and moves to the inside or outside of the office.

The gate 100 only needs to be an existing entrance/exit determination device that can determine the entrance of a user into the office or the exit of a user out of the office. The gate 100 may also include a function of opening/closing a flapper gate (paddle gate or flapper gate) and a function of unlocking a door. Moreover, the gate 100 may also include a biometric authentication function.

The management server 200r manages the state of each user (inside/outside the office), the operational state of a terminal owned by each user, policies set on the terminals, and the like. The management server 200r operates in cooperation with the existing gate 100 and thereby can control the operation mode of each terminal.

Here, it is assumed that the terminal A (terminal ID=A) and terminal B (terminal ID=B) owned by a user 0001 are a mobile telephone that supports a cellular network and a note PC that does not support a cellular network, respectively.

### 4.2) Example of Mode Changing Through Push Communication

The management server, when detecting that the user has passed the gate, instructs each of the terminals A and B to change the mode from “outside office” to “inside office”.

Referring to FIG. 28, when the user 400 holds, for example, a contactless employee ID card over and passes the gate 100, identification information and the like of the user 400 is notified from the gate 100 to the management server 200r (Operation S401), and the management server 200r sends an instruction to change the policy set on each of the terminals A and B, which are owned by the user 400, to a mode for the use inside the office (Operation S402). Thereby, the respective user state information and mode information for the terminals A and B stored in a user information DB 202 are updated to “inside office” individually.

The terminals A and B having received the instruction to change the mode setting change the respective set policies from “private” to “inside office”. Policy information to be set may be stored in each terminal beforehand and changed in response to an instruction to change the mode setting, or policy information itself may be received from the management server 200r. Here, since the terminal A is capable of using a cellular network, the setting is changed, for example, from the policy C to the policy A shown in FIG. 6, whereas since the terminal B is incapable of using a cellular network, the setting is changed, for example, from the policy C to the policy B shown in FIG. 6. However, the policies shown in FIG. 6 are examples, and policies can be created by combining various controls such as restriction on the use of applications, devices and the like, as described in the first exemplary embodiment.

### 4.3) Example of Mode Changing Through Pull Communication

The management server, when detecting that a user has passed the gate, instructs each of terminals owned by this user to change the mode from “outside office” to “inside office” in response to a pull communication from at least one of the plurality of terminals owned by this user. Hereinafter, it is assumed that the terminals A and B owned by the user 400 are registered with the management server beforehand.

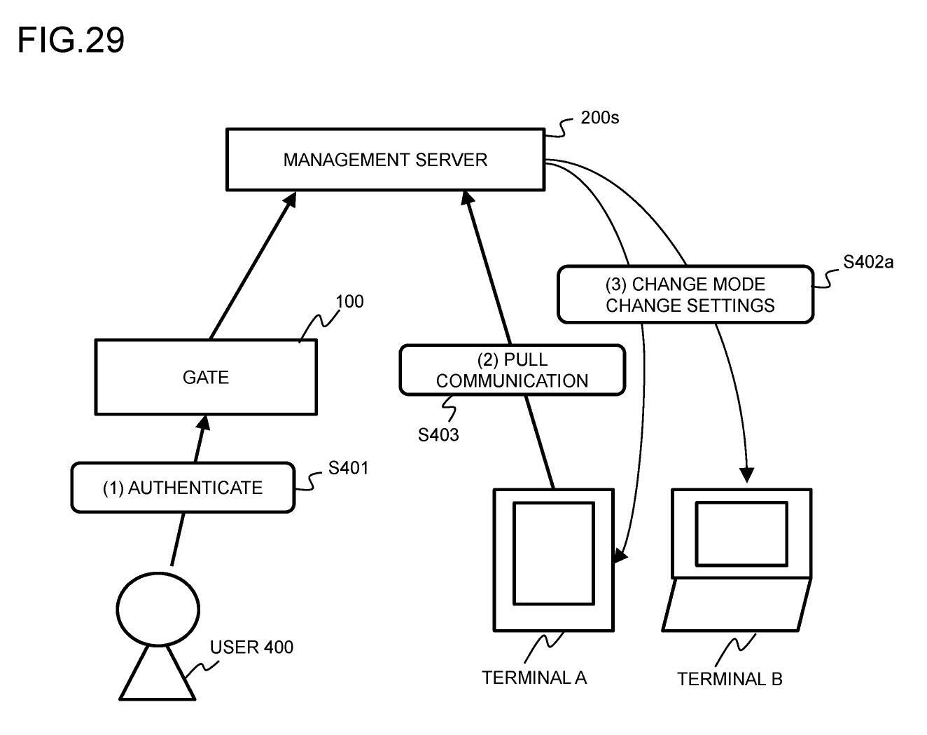

Referring to FIG. 29, when the user 400 passes the gate 100, identification information and the like of the user 400 is notified from the gate 100 to a management server 200s (Operation S401). Subsequently, the client of the terminal A is activated, and pull communication to the management server 200s is performed (Operation S403).

Upon receiving the pull communication from the terminal A, the management server 200s searches for the other terminal B of the user owning this terminal A and instructs these terminals A and B to change the mode or to change the policy settings (Operation S402a). Through the above-described operations, the respective policies of the terminals A and B owned by the user 400 are changed to “inside office” policies, respectively. As mentioned above, since the terminal A is capable of using a cellular network, the setting is changed, for example, from the policy C to the policy A shown in FIG. 6, whereas since the terminal B is incapable of using a cellular network, the setting is changed, for example, from the policy C to the policy B shown in FIG. 6.

Note that the above-described example illustrates a case where pull communication by the terminal A is triggered by the activation of the client of the terminal A, but it is also possible to perform similar pull communication when the terminal A or B is turned on.

### 5. Fifth Exemplary Embodiment

In the above-described exemplary embodiments, the gate and management server are separated. However, a management server may be mounted on a gate.

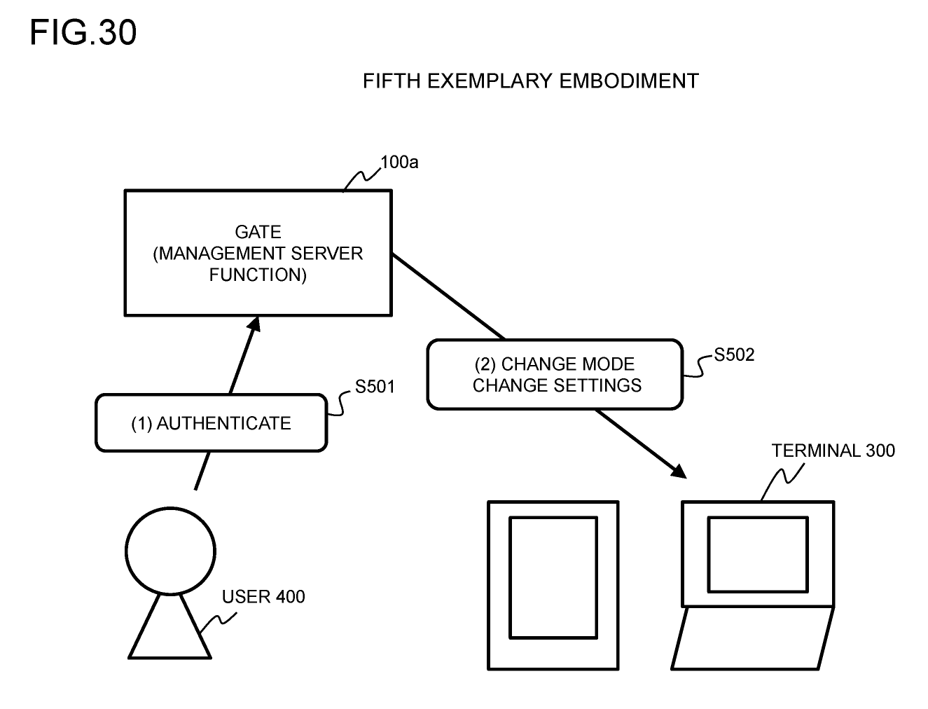

Referring to FIG. 30, in a management system according to a fifth exemplary embodiment of the present invention, the above-described functionality of the management server 200 is mounted on a gate 100a. When a user 400 passes the gate 100a (Operation S501), the management server function uses identification information and the like of the user 400 to send an instruction to change the policy set on a terminal 300 privately owned by the user 400 to a mode for the use inside the office (Operation S502). The gate function of the gate 100a and the management server function are similar to those already described, and therefore a description thereof will be omitted.

### 6. Sixth Exemplary Embodiment

In the above-described exemplary embodiments, the gate 100 is used for a user's entrance/exit determination device. However, the present invention is not limited to such a case. It is also possible to cause a specified terminal to function as a user determination device for determining a use's arriving at or leaving the office.

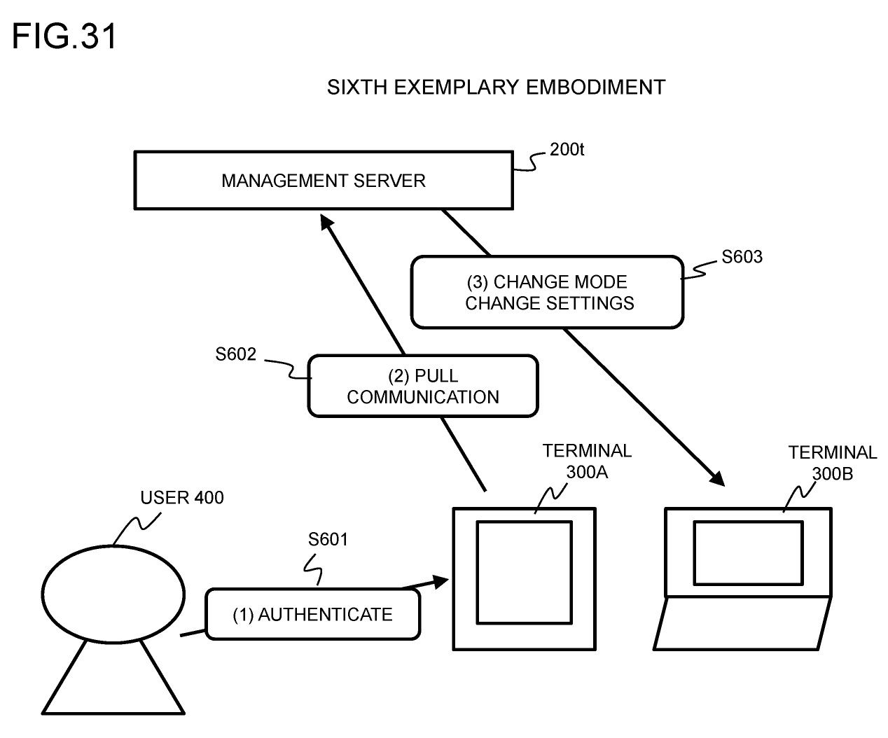

Referring to FIG. 31, a management system according to a sixth exemplary embodiment of the present invention includes a management server 200t, a terminal 300A functioning as a user determination device, and a terminal 300B owned by a user 400. The user 400 may be the owner of both the terminals 300A and 300B but here is assumed to be the owner of only the terminal 300B. When the user 400 touches a contactless employee ID card onto the terminal 300A, the terminal 300A authenticates the user 400 (Operation S601). When authentication is successfully done, the terminal 300A performs pull communication to the management server 200t (Operation S602).

Upon receiving the pull communication from the terminal 300A, the management server 200t searches for the terminal 300B owned by the user 400 and instructs the terminal 300B to change the mode or to change the policy settings (Operation S603). Through the above-described operations, the policy of the terminal 300B owned by the user 400 is changed to an “inside office” policy.

According to the present exemplary embodiment, although the terminal 300A needs to be equipped with a contactless IC reader and a function for pull communication to the management server 200t, the other terminal 300B can perform mode changing control as in the above-described exemplary embodiments.

### 7. Seventh Exemplary Embodiment

In the above-described exemplary embodiments, a user's entrance/exit is determined by using the gate 100 or a terminal as a user determination device. However, the present invention is not limited to such cases. According to a seventh exemplary embodiment of the present invention, the mode can be changed not only based on spatial user state determination by the gate 100, but also based on temporal user state determination in cooperation with an intra-company scheduling system.

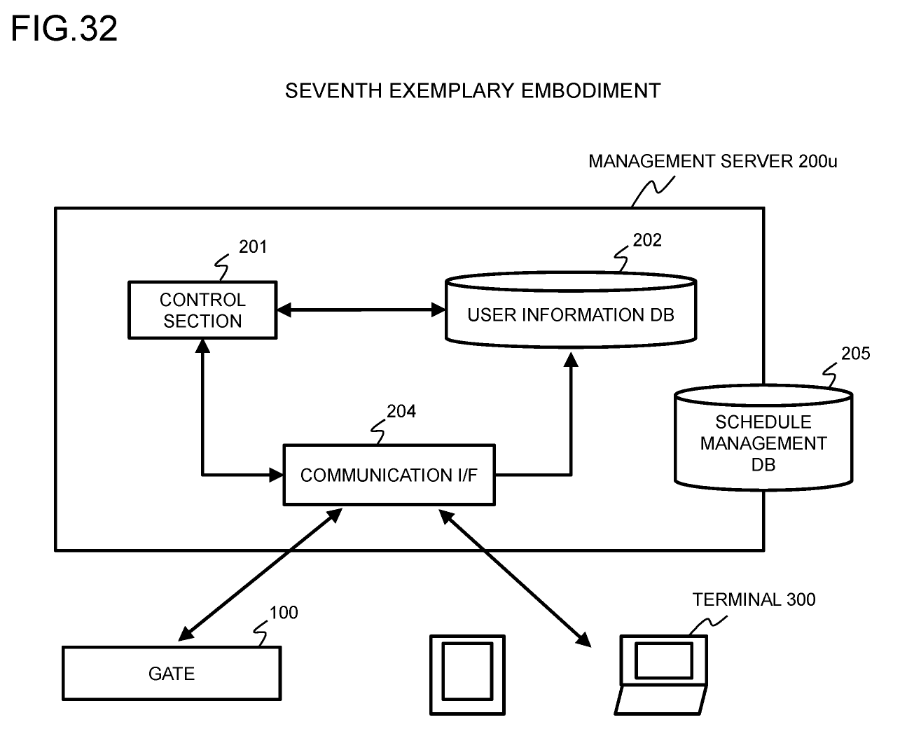

Referring to FIG. 32, a management server 200u according to the present exemplary embodiment includes a control section 201, a user information DB 202 including policy information, a communication interface 204 and a schedule management database 205. The basic operation of the management server 200u is similar to that of the management server 200 according to the first exemplary embodiment, with the difference that the management server 200u performs policy changing control by referring to the schedule management database 205.

The schedule management database 205 stores, for example, information on users' (employees′) schedules (a period in a day a user is out of office, a place a user goes to, etc.), periods in a day the user accesses intra-office PCs from outside, and the like. Hereinafter, operation in the management system according to the present exemplary embodiment will be described by taking examples of changing in case of moving to the outside of the office in the second exemplary embodiment (FIGS. 17 and 18) as an example.

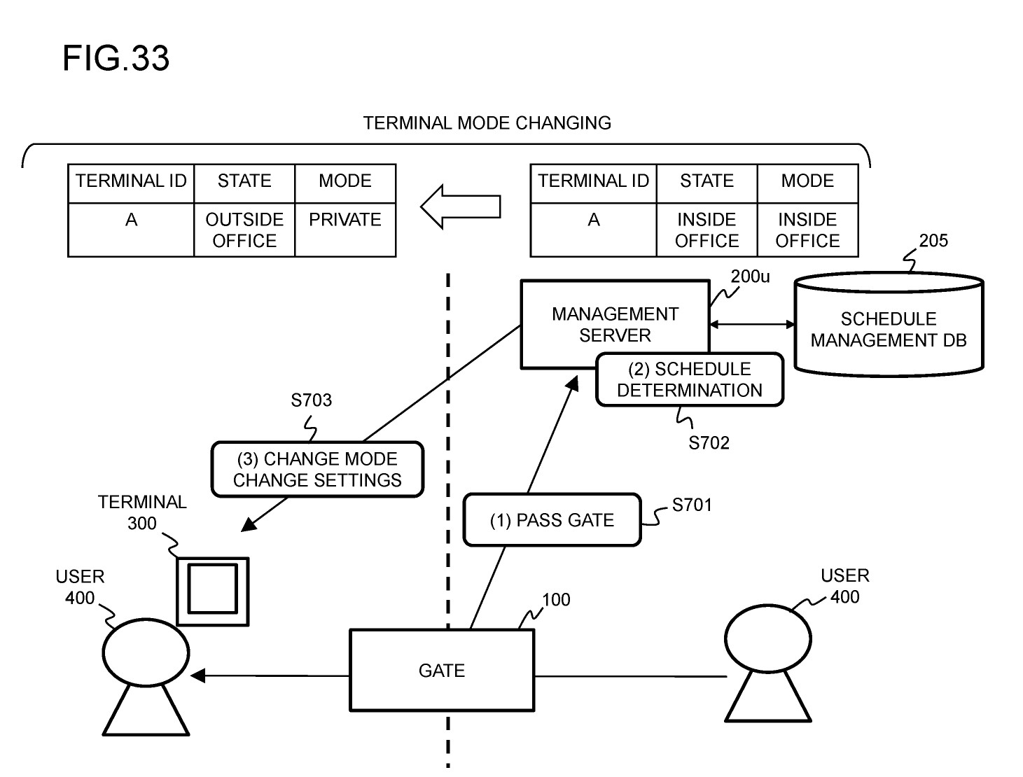

Referring to FIG. 33, the management server 200u can refer to the schedule of a user 400 in cooperation with the schedule management database 205 in the office. The management server 200u, when detecting that the user has passed the gate 100 and gone to the outside of the office (Operation S701), refers to the schedule management database 205 and determines whether or not the current time falls within a scheduled time period (e.g., out of office from 9:00-11:00″ or the like) registered by the user 400 beforehand (Operation S702).

When the current time is out of the scheduled time period, the management server 200u directly instructs the relevant terminal 300 to change to the “outside office” mode (Operation S703). Thereby, the user state information and mode information for the terminal A (terminal 300) stored in the user information DB 202 are changed to “outside office” and “private”, respectively, as shown at the top of FIG. 33. The terminal 300 having received the instruction to change the mode setting changes the set policy from “inside office” to “private”. Policy information to be set may be stored in the terminal 300 beforehand and changed in response to an instruction to change the mode setting, or policy information itself may be received from the management server 200u.

When the current time falls within the scheduled time period, the user 400 is likely to use the terminal 300 to do work. Accordingly, even if the user 400 has gone out of the gate 100, the management server 200u keeps the mode of the “inside office” policy, or changes the mode to that of a less restrictive policy even though the policy is for “outside office”, when the current time falls within the scheduled time period, thus allowing the terminal 300 to be used in the “inside office” mode or “quasi inside office” mode.

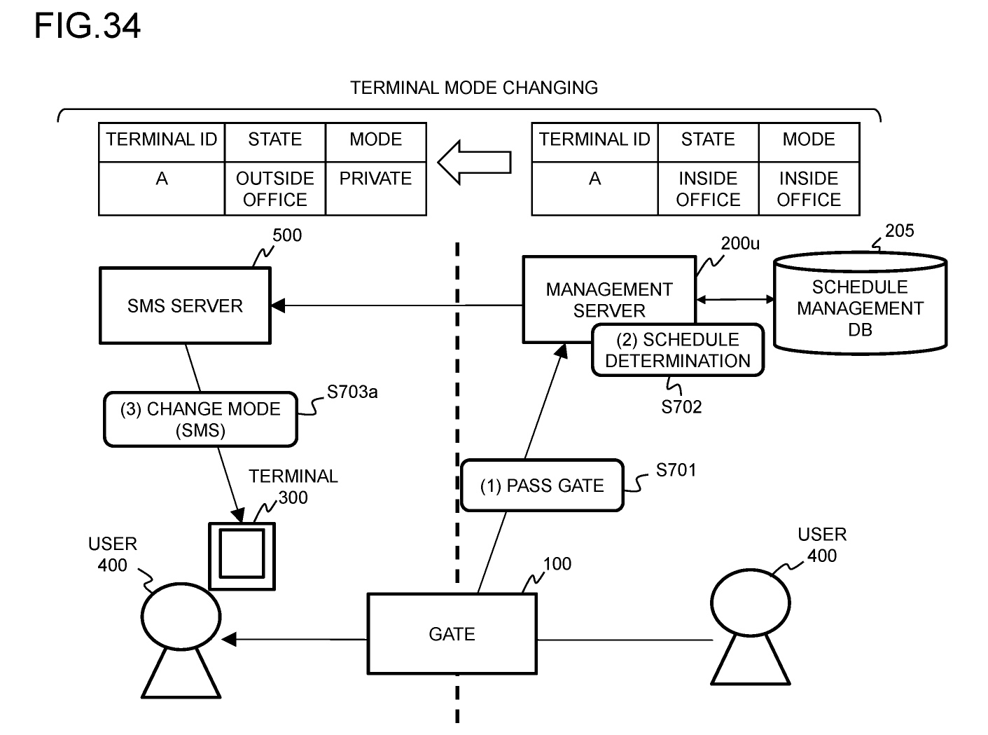

Moreover, it is also possible to send an instruction to change the mode or an instruction to set a mode to the terminal 300 via an SMS serer 500 as shown in FIG. 34 (Operation S703a). Furthermore, it is also possible to perform mode changing control at the time of moving to the outside of the office, as shown as the second exemplary embodiment in FIGS. 19 to 22. Further, a plurality of terminals may be the targets of mode changing control, as described in the fourth exemplary embodiment.

### 8. Eighth Exemplary Embodiment

According to an eighth exemplary embodiment of the present invention, an employee ID function is incorporated in a terminal A having a Wireless LAN function, whereby it is possible to change the mode of a user's another terminal B. For the terminal A, for example, a terminal having a tethering function can be used.

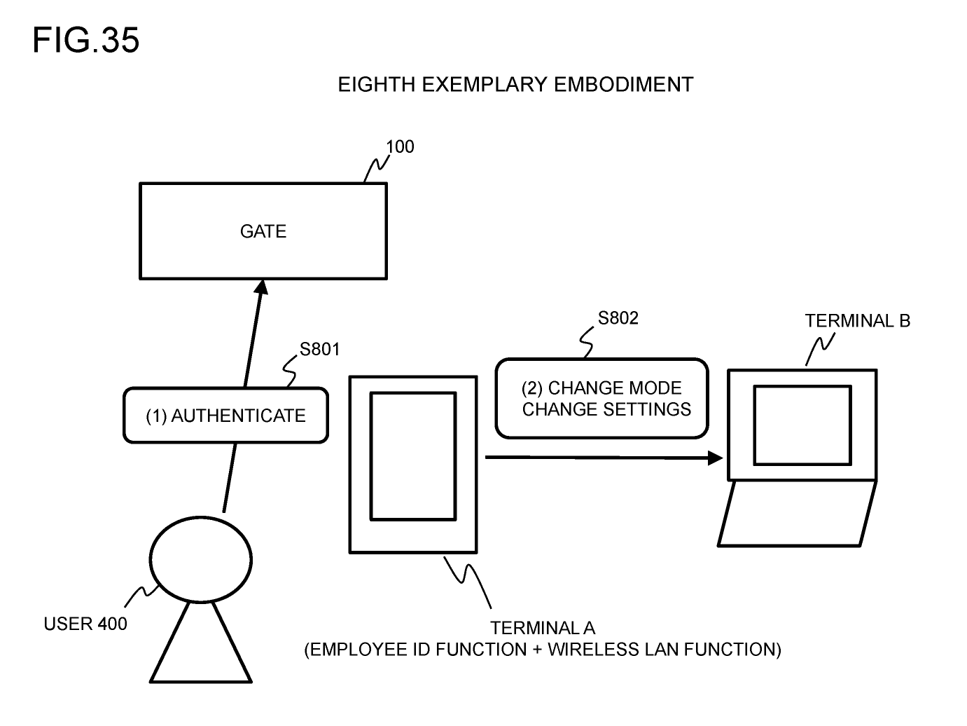

Referring to FIG. 35, in a management system according to the eighth exemplary embodiment of the present invention, a user 400 brings the terminal A, which has an employee ID function and a Wireless LAN function, closer to a gate 100 and thereby passes the gate 100 (Operation S801). At this time, the terminal A sends an instruction to change the policy set on the terminal B owned by the user 400 via a wireless LAN (Operation S802). Thus, the policy set on the terminal B owned by the user can be directly changed without authentication by a management server.

The invention of the present application has been described with reference to the first to eighth exemplary embodiments hereinabove. However, the invention of the present application is not limited to the above-described embodiments. Various changes comprehensible to those ordinarily skilled in the art can be made to the architectures, configurations and operations according to the invention of the present application within the scope of the technical ideas of the invention of the present application.

### 9. Additional Statements

Part or all of the above-described exemplary embodiments also can be stated as in, but are not limited to, the following additional statements.

### (Additional Statement 1)

A management system for managing a terminal owned by a user, characterized by comprising:

an entrance/exit determination device that determines the user's entrance into or exit from a predetermined place; and

a management device that determines an operation policy based on at least a result of the determination made by the entrance/exit determination device and sets the determined operation policy on the terminal owned by the user.

### (Additional Statement 2)

The management system according to additional statement 1, characterized in that the entrance/exit determination device determines the entrance/exit by using a user identification means other than the terminal.

### (Additional Statement 3)

The management system according to additional statement 1 or 2, characterized in that the terminal sets the determined operation policy in accordance with an instruction to change a policy from the management device.

### (Additional Statement 4)

The management system according to any one of additional statements 1 to 3, characterized in that the management device sets the operation policies on a plurality of terminals owned by the user.

### (Additional Statement 5)

The management system according to any one of additional statements 1 to 4, characterized in that the management device determines the operation policies, which differ in functional restriction, depending on whether or not the terminal supports a cellular network.

### (Additional Statement 6)

The management system according to additional statement 4 or 5, characterized in that the management device sets the operation policies on the plurality of terminals in response to a request from one of the plurality of terminals.

### (Additional Statement 7)

The management system according to any one of additional statements 1 to 6, characterized in that the entrance/exit determination device is a gate having a function of authenticating the user.

### (Additional Statement 8)

The management system according to any one of additional statements 1 to 7, characterized in that the management device is provided to a server, and the terminal is a client of the server.

### (Additional Statement 9)

The management system according to any one of additional statements 1 to 8, characterized in that the management device sends an instruction to change a policy to the terminal by means of push communication.

### (Additional Statement 10)

The management system according to any one of additional statements 1 to 8, characterized in that the management device sends an instruction to change a policy to the terminal by means of pull communication from the terminal.

### (Additional Statement 11)

The management system according to any one of additional statements 1 to 8, characterized in that the management device sends a message for changing a policy to the terminal via a short message service (SMS) server, and the terminal changes the operation policy in accordance with the message for changing a policy.

### (Additional Statement 12)

The management system according to any one of additional statements 1 to 8, characterized in that the management device sends the instruction to change a policy to the terminal in response to a request for authentication from the terminal that has received the message for changing a policy via a short message service (SMS) server.

### (Additional Statement 13)

The management system according to any one of additional statements 1 to 8, characterized in that the terminal sets the determined operation policy in accordance with an instruction to change a policy from the management device after the terminal is authenticated by an access point installed inside the predetermined place or by an authentication server installed inside or outside the predetermined place.

### (Additional Statement 14)

The management system according to any one of additional statements 1 to 13, characterized in that the management device determines the operation policy further in accordance with a pre-registered schedule of the user and sets the determined operation policy on the terminal owned by the user.

### (Additional Statement 15)

The management system according to additional statement 14, characterized in that, even if the user is located out of the predetermined place, the management device determines the operation policy, which is provided for an inside of the predetermined place, and sets the determined operation policy on the terminal owned by the user when it is a time falling within the scheduled period.

### (Additional Statement 16)

A management method for managing a terminal owned by a user, characterized by comprising:

by an entrance/exit determination device, determining the user's entrance into or exit from a predetermined place; and

by a management device, determining an operation policy based on at least a result of the determination made by the entrance/exit determination device and setting the determined operation policy on the terminal owned by the user.

### (Additional Statement 17)

The management method according to additional statement 16, characterized in that the entrance/exit determination device determines the entrance/exit by using a user identification means other than the terminal.

### (Additional Statement 18)

The management method according to additional statement 16 or 17, characterized in that the terminal sets the determined operation policy in accordance with an instruction to change a policy from the management device.

### (Additional Statement 19)

The management method according to any one of additional statements 16 to 18, characterized in that the management device sets the operation policies on a plurality of terminals owned by the user.

### (Additional Statement 20)

The management method according to any one of additional statements 16 to 19, characterized in that the management device determines the operation policies, which differ in functional restriction, depending on whether or not the terminal supports a cellular network.

### (Additional Statement 21)

The management method according to additional statement 19 or 20, characterized in that the management device sets the operation policies on the plurality of terminals in response to a request from one of the plurality of terminals.

### (Additional Statement 22)

The management method according to any one of additional statements 16 to 21, characterized in that the entrance/exit determination device is a gate having a function of authenticating the user.

### (Additional Statement 23)

The management method according to any one of additional statements 16 to 22, characterized in that the management device is provided to a server, and the terminal is a client of the server.

### (Additional Statement 24)

The management method according to any one of additional statements 16 to 23, characterized in that the management device sends an instruction to change a policy to the terminal by means of push communication.

### (Additional Statement 25)

The management method according to any one of additional statements 16 to 23, characterized in that the management device sends an instruction to change a policy to the terminal by means of pull communication from the terminal.

### (Additional Statement 26)

The management method according to any one of additional statements 16 to 23, characterized in that the management device sends a message for changing a policy to the terminal via a short message service (SMS) server, and the terminal changes the operation policy in accordance with the message for changing a policy.

### (Additional Statement 27)

The management method according to any one of additional statements 16 to 23, characterized in that the management device sends the instruction to change a policy to the terminal in response to a request for authentication from the terminal that has received the message for changing a policy via a short message service (SMS) server.

### (Additional Statement 28)

The management method according to any one of additional statements 16 to 23, characterized in that the terminal sets the determined operation policy in accordance with an instruction to change a policy from the management device after the terminal is authenticated by an access point installed inside the predetermined place or by an authentication server installed inside or outside the predetermined place.

### (Additional Statement 29)

The management method according to any one of additional statements 16 to 28, characterized in that the management device determines the operation policy further in accordance with a pre-registered schedule of the user and sets the determined operation policy on the terminal owned by the user.

### (Additional Statement 30)

The management method according to additional statement 29, characterized in that, even if the user is located out of the predetermined place, the management device determines the operation policy, which is provided for an inside of the predetermined place, and sets the determined operation policy on the terminal owned by the user when it is a time falling within the scheduled period.

### (Additional Statement 31)

A management server for managing a terminal owned by a user, characterized by comprising:

a policy determination means for determining an operation policy of the terminal owned by the user, based on user information including at least a result of determination from an entrance/exit determination device, which determines the user's entrance into or exit from a predetermined place; and

a communication control means that notifies information on the determined operation policy to the terminal owned by the user.

### (Additional Statement 32)

The management server according to additional statement 31, characterized in that the entrance/exit determination device determines the entrance/exit by using a user identification means other than the terminal.

### (Additional Statement 33)

The management server according to additional statement 31 or 32, characterized in that the policy determination means sets the operation policies on a plurality of terminals owned by the user.

### (Additional Statement 34)

The management server according to any one of additional statements 31 to 33, characterized in that the policy determination means determines the operation policies, which differ in functional restriction, depending on whether or not the terminal supports a cellular network.

### (Additional Statement 35)

The management server according to any one of additional statements 31 to 34, characterized in that the policy determination means sets the operation policies on the plurality of terminals in response to a request from one of the plurality of terminals.

### (Additional Statement 36)

The management server according to any one of additional statements 31 to 35, characterized in that the entrance/exit determination device is a gate having a function of authenticating the user.

### (Additional Statement 37)

The management server according to any one of additional statements 31 to 36, characterized in that the terminal is a client of this management server.

### (Additional Statement 38)

The management server according to any one of additional statements 31 to 37, characterized in that the communication control means sends an instruction to change a policy to the terminal by means of push communication.

### (Additional Statement 39)

The management server according to any one of additional statements 31 to 37, characterized in that the communication control means sends an instruction to change a policy to the terminal by means of pull communication from the terminal.

### (Additional Statement 40)

The management server according to any one of additional statements 31 to 37, characterized in that the communication control means sends a message for changing a policy to the terminal via a short message service (SMS) server, and the terminal changes the operation policy in accordance with the message for changing a policy.

### (Additional Statement 41)

The management server according to any one of additional statements 31 to 37, characterized in that the communication control means sends the instruction to change a policy to the terminal in response to a request for authentication from the terminal that has received the message for changing a policy via a short message service (SMS) server.

### (Additional Statement 42)

The management server according to any one of additional statements 31 to 37, characterized in that the communication control means sends an instruction to change a policy to the terminal after the terminal is authenticated by an access point installed inside the predetermined place or by an authentication server installed inside or outside the predetermined place.

### (Additional Statement 43)

The management server according to any one of additional statements 31 to 42, characterized in that the policy determination means determines the operation policy further in accordance with a pre-registered schedule of the user and sets the determined operation policy on the terminal owned by the user.

### (Additional Statement 44)

The management server according to additional statement 43, characterized in that, even if the user is located out of the predetermined place, the policy determination means determines the operation policy, which is provided for an inside of the predetermined place, and sets the determined operation policy on the terminal owned by the user when it is a time falling within the scheduled period.

### (Additional Statement 45)

A communication terminal owned by a user that is managed by a management server in a management system, wherein the management system includes an entrance/exit determination device that determines the user's entrance into or exit from a predetermined place, and the management server that determines an operation policy based on at least a result of the determination made by the entrance/exit determination device, characterized by comprising:

a policy setting means for setting an operation policy determined by the management server; and

a control means for controlling operation of this communication terminal through functional settings according to the operation policy.

### (Additional Statement 46)

The communication terminal according to additional statement 45, characterized in that the entrance/exit determination device determines the entrance/exit by using a user identification means other than this communication terminal.

### (Additional Statement 47)

The communication terminal according to additional statement 45 or 46, characterized in that the policy setting means sets the determined operation policy in accordance with an instruction to change a policy from the management device.

### (Additional Statement 48)

A terminal control method for a management server that manages a terminal owned by a user, characterized by comprising:

by the policy determination means, determining an operation policy of the terminal owned by the user, based on user information including at least a result of determination from an entrance/exit determination device, which determines the user's entrance into or exit from a predetermined place; and

by a communication control means, notifying information on the determined operation policy to the terminal owned by the user.

### (Additional Statement 49)

The terminal control method for the management server according to additional statement 48, characterized in that the entrance/exit determination device determines the entrance/exit by using a user identification means other than the terminal.

### (Additional Statement 50)

The terminal control method for the management server according to additional statement 48 or 49, characterized in that the policy determination means sets the operation policies on a plurality of terminals owned by the user.

### (Additional Statement 51)

The terminal control method for the management server according to any one of additional statements 48 to 50, characterized in that the policy determination means determines the operation policies, which differ in functional restriction, depending on whether or not the terminal supports a cellular network.

### (Additional Statement 52)

The terminal control method for the management server according to any one of additional statements 48 to 51, characterized in that the policy determination means sets the operation policies on the plurality of terminals in response to a request from one of the plurality of terminals.

### (Additional Statement 53)

The terminal control method for the management server according to any one of additional statements 48 to 52, characterized in that the entrance/exit determination device is a gate having a function of authenticating the user.

### (Additional Statement 54)

The terminal control method for the management server according to any one of additional statements 48 to 53, characterized in that the terminal is a client of this management server.

### (Additional Statement 55)

A control method for a communication terminal owned by a user that is managed by a management server in a management system, wherein the management system includes an entrance/exit determination device that determines the user's entrance into or exit from a predetermined place, and the management server that determines an operation policy based on at least a result of the determination made by the entrance/exit determination device, characterized by comprising:

by a policy setting means, setting an operation policy determined by the management server; and

by a control means, controlling operation of this communication terminal through functional settings according to the operation policy.

### (Additional Statement 56)

The communication terminal according to additional statement 55, characterized in that the entrance/exit determination device determines the entrance/exit by using a user identification means other than this communication terminal.

### (Additional Statement 57)

The control method for the communication terminal according to additional statement 55 or 56, characterized in that the policy setting means sets the determined operation policy in accordance with an instruction to change a policy from the management device.

### (Additional Statement 58)

A management system for managing a terminal owned by a user, characterized by comprising:

an entrance/exit detection device that detects the user's entrance into or exit from a predetermined place; and

a management device that notifies an operation policy of the terminal to this terminal in response to detection of entrance/exit by the entrance/exit determination device.

### (Additional Statement 59)

The management system according to additional statement 58, characterized in that the management device notifies the operation policy to the terminal through a communication system usable by the terminal.

### (Additional Statement 60)

A management method for managing a terminal owned by a user, characterized by comprising:

by an entrance/exit detection device, detecting the user's entrance into or exit from a predetermined place; and

by a management device, notifying an operation policy of the terminal to this terminal in response to the fact that the entrance/exit determination device has detected the entrance/exit.

### (Additional Statement 61)

The management method according to additional statement 60, characterized in that the management device notifies the operation policy to the terminal through a communication system usable by the terminal.

### (Additional Statement 62)

A management server for managing a terminal owned by a user, characterized by comprising:

a communication means that receives from an entrance/exit detection means a notification indicating that the user's entrance into or exit from a predetermined place has been detected; and

a control means that notifies an operation policy of the terminal to this terminal in response to the notification.

### (Additional Statement 63)

The management server according to additional statement 62, characterized in that the control means notifies the operation policy to the terminal through a communication system usable by the terminal.

### (Additional Statement 64)

A communication terminal owned by a user that is managed by a management server, characterized by comprising:

a communication means that receives an operation policy, which is notified by the management server based on a result of detection, from an entrance/exit detection means, of the user's entrance into or exit from a predetermined place; and

a control means for controlling operation of this communication terminal through functional settings according to the operation policy.

### (Additional Statement 65)

The communication terminal according to additional statement 64, characterized in that the communication means receives the operation policy from the management server by using a communication scheme this communication terminal can use.

### (Additional Statement 66)

A terminal control method for a management server that manages a terminal owned by a user, characterized by comprising:

by a communication means, receiving from an entrance/exit detection means a notification indicating that the user's entrance into or exit from a predetermined place has been detected; and

by a control means, notifying an operation policy of the terminal to this terminal in response to the notification.

### (Additional Statement 67)

The terminal control method for the management server according to additional statement 66, characterized in that the control means notifies the operation policy to the terminal through a communication system usable by the terminal.

### (Additional Statement 68)

A control method for a communication terminal owned by a user that is managed by a management server, characterized by comprising:

by a communication means, receiving an operation policy notified by the management server; and

by a control means, controlling operation of this communication terminal through functional settings according to the operation policy.

### (Additional Statement 69)

The communication terminal according to additional statement 68, characterized in that the communication means receives the operation policy from the management server by using a communication scheme this communication terminal can use.

### INDUSTRIAL APPLICABILITY

The present invention is applicable to systems allowing the use of a privately owned terminal in business.

### REFERENCE SIGNS LIST

100 Gate
200 Management server
201 Control section
202 User information database
203 Policy database
204 Communication interface
205 Schedule management database
300 Terminal
310 Communication interface
320 Client
330 Control section
400 User

1. A management system for managing a terminal owned by a user, comprising:
an entrance/exit detection device that detects the user's entrance into or exit from a predetermined place; and
a management device that is configured to notify an operation policy of the terminal to this terminal in response to entrance/exit detection by the entrance/exit detection device.

2. The management system according to claim 1, wherein the management device notifies the operation policy to the terminal through a communication system usable by the terminal.

3. The management system according to claim 1, wherein the terminal sets the operation policy in accordance with an instruction to change a policy from the management device.

4. The management system according to claim 1, wherein the management device notifies operation policies to a plurality of terminals owned by the user.

5. The management system according to claim 1, wherein the management device notifies the operation policy which differs in functional restriction depending on whether the terminal supports a cellular network.

6. The management system according to claim 4, wherein the management device notifies the operation policies to the plurality of terminals in response to a request from one of the plurality of terminals.

7. The management system according to claim 1, wherein the entrance/exit detection device is a gate having a function of authenticating the user.

8. The management system according to claim 1, wherein the management device is provided in a server, and the terminal is a client of the server.

9. The management system according to claim 1, wherein the management device notifies the operation policy to the terminal owned by the user further in accordance with a pre-registered schedule of the user.

10. The management system according to claim 9, wherein, even if the user is located out of the predetermined place, the management device notifies the operation policy, which is provided for an inside of the predetermined place, to the terminal owned by the user when it is a time falling within the scheduled period.

11. A management method for managing a terminal owned by a user, comprising:
by an entrance/exit detection device, detecting the user's entrance into or exit from a predetermined place; and
by a management device, notifying an operation policy of the terminal to this terminal in response to detection of entrance/exit by the entrance/exit determination device.

12-20. (canceled)

21. A management server for managing a terminal owned by a user, comprising:
a communication unit that is configured to receives from an entrance/exit detection means a notification indicating that the user's entrance into or exit from a predetermined place has been detected; and
a controller that is configured to notify an operation policy of the terminal to this terminal in response to the notification.

22. The management server according to claim 21, wherein the controller notifies the operation policy to the terminal through a communication system usable by the terminal.

23. The management server according to claim 21, wherein the controller notifies operation policies to a plurality of terminals owned by the user.

24. The management server according to claim 21, wherein the controller notifies the operation policy which differs in functional restriction depending on whether the terminal supports a cellular network.

25. The management server according to claim 23, wherein the controller notifies the operation policies to the plurality of terminals in response to a request from one of the plurality of terminals.

26. The management server according to claim 21, wherein the entrance/exit detection device is a gate having a function of authenticating the user.

27. The management server according to claim 21, wherein the terminal is a client of this management server.

28. The management server according to claim 21, wherein the controller notifies the operation policy to the terminal further in accordance with a pre-registered schedule of the user.

29. The management server according to claim 28, wherein, even if the user is located out of the predetermined place, the controller notifies the operation policy, which is provided for an inside of the predetermined place, to the terminal when it is a time falling within the scheduled period.

30. A communication terminal owned by a user that is managed by a management server, comprising:
a communication unit that is configured to receives from an entrance/exit detection means an operation policy which is notified by the management server based on a result of detection of the user's entrance into or exit from a predetermined place; and
a controller that is configured to control operation of the communication terminal by a functional setting according to the operation policy.

31. The communication terminal according to claim 30, wherein the communication unit receives the operation policy from the management server through a communication system usable by the communication terminal.

32. The communication terminal according to claim 30, wherein the controller sets the operation policy in accordance with an instruction to change a policy from the management server.

33. A terminal control method of a management server that manages a terminal owned by a user, comprising:
by a communication unit, receiving from an entrance/exit detection apparatus a notification indicating that the user's entrance into or exit from a predetermined place has been detected; and
by a controller, notifying an operation policy of the terminal to the terminal in response to the notification.

34. The terminal control method according to claim 33, wherein the controller notifies the operation policy to the terminal through a communication system usable by the terminal.

35. The terminal control method according to claim 33, wherein the controller notifies the operation policies to a plurality of terminals owned by the user.

36. The terminal control method according to claim 33, wherein the controller notifies the operation policy which differs in functional restriction depending on whether or not the terminal supports a cellular network.

37. The terminal control method according to claim 35, wherein the controller notifies operation policies to the plurality of terminals in response to a request from one of the plurality of terminals.

38. The terminal control method according to claim 33, wherein the entrance/exit determination apparatus is a gate having a function of authenticating the user.

39. The terminal control method according to claim 33, wherein the terminal is a client of this management server.

40-42. (canceled)
